(19) United States
(12) Patent Application Publication
(10) Pub. No.: US 2025/0237910 A1
(43) Pub. Date: Jul. 24, 2025

(54) OPTICAL ELEMENT AND LIGHTING DEVICE

(71) Applicant: Japan Display Inc., Tokyo (JP)

(72) Inventors: Kojiro IKEDA, Tokyo (JP); Takeo KOITO, Tokyo (JP); Yoshikatsu IMAZEKI, Tokyo (JP)

(21) Appl. No.: 19/175,852

(22) Filed: Apr. 10, 2025

Related U.S. Application Data
(63) Continuation of application No. PCT/JP2023/032101, filed on Sep. 1, 2023.

(30) Foreign Application Priority Data
Oct. 19, 2022 (JP) 2022-167919

(51) Int. Cl. G02F 1/1343; G02F 1/1347

(52) U.S. Cl. CPC G02F 1/134309; G02F 1/1347

(57) ABSTRACT

An optical element includes at least two stacked liquid crystal cells. Each of at least two liquid crystal cells includes a first substrate on which first and second connection pads are electrically connected to first and second electrodes, respectively, and a second substrate on which third and fourth connection pads are electrically connected to third and fourth electrodes, respectively. The first connection pads between at least two liquid crystal cells, the second connection pads between at least two liquid crystal cells, the third connection pads between at least two liquid crystal cells, and the fourth connection pads between at least two liquid crystal cells are electrically connected to each other via inter-cell conductive electrodes.

### CROSS-REFERENCE TO RELATED APPLICATIONS

This application is a Continuation of International Patent Application No. PCT/JP2023/032101, filed on Sep. 1, 2023, which claims the benefit of priority to Japanese Patent Application No. 2022-167919, filed on Oct. 19, 2022, the entire contents of which are incorporated herein by reference.

### FIELD

An embodiment of the present invention relates to an optical element using a liquid crystal to control a distribution of light emitted from a light source. Further, an embodiment of the present invention relates to a lighting device including the optical element.

### BACKGROUND

An optical element which is a so-called liquid crystal lens has been conventionally known in which a change in the refractive index of a liquid crystal is utilized by adjusting a voltage applied to the liquid crystal. Further, a lighting device including a light source and a liquid crystal lens has been developed (for example, see Japanese laid-open patent publication No. 2021-117344).

### SUMMARY

An optical element according to an embodiment of the present invention includes a first liquid crystal cell, a second liquid crystal cell, a third liquid crystal cell, and a fourth liquid crystal cell stacked in sequence. Each of the first liquid crystal cell, the second liquid crystal cell, the third liquid crystal cell, and the fourth liquid crystal cell includes a first substrate on which a first electrode, a second electrode, a first connection pad electrically connected to the first electrode, and a second connection pad electrically connected to the second electrode are provided, a second substrate on which a third electrode, a fourth electrode, a third connection pad electrically connected to the third electrode, and a fourth connection pad electrically connected to the fourth electrode are provided, and a liquid crystal layer provided between the first substrate and the second substrate. The second substrate of the second liquid crystal cell faces the second substrate of the first liquid crystal cell. The first substrate of the third liquid crystal cell faces the first substrate of the second liquid crystal cell. The second substrate of the fourth liquid crystal cell faces the second substrate of the third liquid crystal cell. The first connection pad of the first liquid crystal cell is electrically connected to the first connection pad of the third liquid crystal cell via a first inter-cell conductive electrode. The second connection pad of the first liquid crystal cell is electrically connected to the second connection pad of the third liquid crystal cell via a second inter-cell conductive electrode. The third connection pad of the first liquid crystal cell is electrically connected to the third connection pad of the third liquid crystal cell via a third inter-cell conductive electrode. The fourth connection pad of the first liquid crystal cell is electrically connected to the fourth connection pad of the third liquid crystal cell via a fourth inter-cell conductive electrode. The first connection pad of the second liquid crystal cell is electrically connected to the first connection pad of the fourth liquid crystal cell via a fifth inter-cell conductive electrode. The second connection pad of the second liquid crystal cell is electrically connected to the second connection pad of the fourth liquid crystal cell via a sixth inter-cell conductive electrode. The third connection pad of the second liquid crystal cell is electrically connected to the third connection pad of the fourth liquid crystal cell via a seventh inter-cell conductive electrode. The fourth connection pad of the second liquid crystal cell is electrically connected to the fourth connection pad of the fourth liquid crystal cell via an eighth inter-cell conductive electrode.

An optical element according to an embodiment of the present invention includes a first liquid crystal cell, a second liquid crystal cell, a third liquid crystal cell, and a fourth liquid crystal cell stacked in sequence. Each of the first liquid crystal cell, the second liquid crystal cell, the third liquid crystal cell, and the fourth liquid crystal cell includes a first substrate on which a first electrode, a second electrode, a first connection pad electrically connected to the first electrode, and a second connection pad electrically connected to the second electrode are provided, a second substrate on which a third electrode, a fourth electrode, a third connection pad electrically connected to the third electrode, and a fourth connection pad electrically connected to the fourth electrode are provided, and a liquid crystal layer provided between the first substrate and the second substrate. The second substrate of the second liquid crystal cell faces the second substrate of the first liquid crystal cell. The first substrate of the third liquid crystal cell faces the first substrate of the second liquid crystal cell. The second substrate of the fourth liquid crystal cell faces the second substrate of the third liquid crystal cell. The third connection pad of the second liquid crystal cell is electrically connected to the first connection pad of the third liquid crystal cell via a first inter-cell conductive electrode. The fourth connection pad of the second liquid crystal cell is electrically connected to the second connection pad of the third liquid crystal cell via a second inter-cell conductive electrode. The first connection pad of the second liquid crystal cell is electrically connected to the third connection pad of the third liquid crystal cell via a third inter-cell conductive electrode. The second connection pad of the second liquid crystal cell is electrically connected to the fourth connection pad of the third liquid crystal cell via a fourth inter-cell conductive electrode. The second connection pad of the first liquid crystal cell is electrically connected to the first connection pad of the fourth liquid crystal cell via a fifth inter-cell conductive electrode. The first connection pad of the first liquid crystal cell is electrically connected to the second connection pad of the fourth liquid crystal cell via a sixth inter-cell conductive electrode. The fourth connection pad of the first liquid crystal cell is electrically connected to the third connection pad of the fourth liquid crystal cell via a seventh inter-cell conductive electrode. The third connection pad of the first liquid crystal cell is electrically connected to the fourth connection pad of the fourth liquid crystal cell via an eighth inter-cell conductive electrode.

A lighting device according to an embodiment of the present invention includes the optical element and a light source disposed adjacent to the first liquid crystal cell.

### BRIEF DESCRIPTION OF DRAWINGS

FIG. 1 is a schematic perspective view showing a configuration of a lighting device in the First Embodiment.

FIG. 2 is a schematic exploded perspective view showing a configuration of an optical element in the First Embodiment.

FIG. 3 is a schematic perspective view showing a configuration of a liquid crystal cell included in an optical element in the First Embodiment.

FIG. 4A is a schematic cross-sectional view showing a configuration of a liquid crystal cell included in an optical element in the First Embodiment.

FIG. 4B is a schematic cross-sectional view showing a configuration of a liquid crystal cell included in an optical element in the First Embodiment.

FIG. 5A is a schematic plan view illustrating an electrode pattern of a liquid crystal cell included in an optical element in the First Embodiment.

FIG. 5B is a schematic plan view illustrating an electrode pattern of a liquid crystal cell included in an optical element in the First Embodiment.

FIG. 6A is a schematic diagram illustrating optical characteristics of a liquid crystal cell in the First Embodiment.

FIG. 6B is a schematic diagram illustrating optical characteristics of a liquid crystal cell in the First Embodiment.

FIG. 7A is a plan view (top view) illustrating a configuration of electrical connections of an optical element in the First Embodiment.

FIG. 7B is a plan view (bottom view) illustrating a configuration of electrical connections of an optical element in the First Embodiment.

FIG. 7C is a plan view (front view) illustrating a configuration of electrical connections of an optical element in the First Embodiment.

FIG. 7D is a plan view (right side view) illustrating a configuration of electrical connections of an optical element in the First Embodiment.

FIG. 7E is a plan view (left side view) illustrating a configuration of electrical connections of an optical element in the First Embodiment.

FIG. 7F is a plan view (back view) illustrating a configuration of electrical connections of an optical element in the First Embodiment.

FIG. 7G is a schematic perspective view illustrating a configuration of electrical connections of an optical element in the First Embodiment.

FIG. 8 is a timing chart showing signals input to an optical element for controlling a light distribution having a linear shape in an x-axis direction in the First Embodiment.

FIG. 9 is a timing chart showing signals input to an optical element for controlling a light distribution having a linear shape in a y-axis direction in the First Embodiment.

FIG. 10 is a timing chart showing signals input to an optical element for controlling a light distribution having a circular shape in the First Embodiment.

FIG. 11 is a timing chart showing signals input to an optical element for controlling a light distribution having an elliptical shape in the First Embodiment.

FIG. 12 is a timing chart showing signals input to an optical element for controlling a light distribution having a cross shape in the First Embodiment.

FIG. 13 is another timing chart showing signals input to an optical element for controlling a light distribution having a cross shape in the First Embodiment.

FIG. 14 is a schematic perspective view showing a configuration of a lighting device in the Second Embodiment.

FIG. 15 is a schematic plan view (top view) showing a configuration of an optical element in the Second Embodiment.

FIG. 16 is a schematic perspective view showing a configuration of a lighting device in the Third Embodiment.

FIG. 17A is a schematic plan view (top view) showing a configuration of an optical element in the Third Embodiment.

FIG. 17B is a schematic plan view (bottom view) showing a configuration of an optical element in the Third Embodiment.

FIG. 17C is a schematic plan view (front view) showing a configuration of an optical element in the Third Embodiment.

FIG. 17D is a schematic plan view (right side view) showing a configuration of an optical element in the Third Embodiment.

FIG. 17E is a schematic plan view (left side view) showing a configuration of an optical element in the Third Embodiment.

FIG. 17F is a schematic plan view (back view) showing a configuration of an optical element in the Third Embodiment.

FIG. 18 is a schematic perspective view showing a configuration of a lighting device in the Fourth Embodiment.

FIG. 19 is a schematic exploded perspective view showing a configuration of an optical element in the Fourth Embodiment.

FIG. 20A is a schematic plan view (top view) showing the configuration of an optical element in the Fourth Embodiment.

FIG. 20B is a schematic plan view (bottom view) showing a configuration of an optical element in the Fourth Embodiment.

FIG. 20C is a schematic plan view (front view) showing a configuration of an optical element in the Fourth Embodiment.

FIG. 20D is a schematic plan view (right side view) showing a configuration of an optical element in the Fourth Embodiment.

FIG. 20E is a schematic plan view (left side view) showing a configuration of an optical element in the Fourth Embodiment.

FIG. 20F is a schematic plan view (back view) showing a configuration of an optical element in the Fourth Embodiment.

FIG. 20G is a schematic perspective view illustrating a configuration of electrical connections of an optical element in the Fourth Embodiment.

FIG. 21 is a timing chart showing signals input to an optical element for controlling a light distribution having a linear shape in an x-axis direction in the Fourth Embodiment.

FIG. 22 is a timing chart showing signals input to an optical element for controlling a light distribution having a linear shape in a y-axis direction in the Fourth Embodiment.

FIG. 23 is a timing chart showing signals input to an optical element for controlling a light distribution having a circular shape in the Fourth Embodiment.

FIG. 24 is a timing chart showing signals input to an optical element for controlling a light distribution having an elliptical shape in the Fourth Embodiment.

FIG. 25 is a timing chart showing signals input to an optical element for controlling a light distribution having a cross shape in the Fourth Embodiment.

FIG. 26 is another timing chart showing signals input to an optical element for controlling a light distribution having a cross shape in the Fourth Embodiment.

### DESCRIPTION OF EMBODIMENTS

In general, a FPC is connected to each of a plurality of liquid crystal cells in an optical element including a plurality of liquid crystal cells. That is, it is common to drive the optical element using a plurality of FPCs. However, since the number of wirings is increased in such an optical element, the mounting process may be complicated and the manufacturing cost may be increased.

In view of the above problems, an embodiment of the present invention can provide an optical element having electrical connections capable of simultaneously driving a plurality of liquid crystal cells by inputting one signal. Further, an embodiment of the present invention can provide a lighting device including the optical element.

In the following description, each of the embodiments of the present invention is described with reference to the drawings. However, the present invention can be implemented in various modes without departing from the gist of the invention and should not be interpreted as being limited to the description of the embodiments exemplified below.

Although the drawings may be schematically represented in terms of width, thickness, shape, and the like of each part as compared with their actual mode in order to make explanation clearer, they are only an example and an interpretation of the present invention is not limited. In addition, in the drawings, the same reference numerals are provided to the same elements as those described previously with reference to preceding figures and repeated explanations may be omitted accordingly.

In the case when a single film is processed to form a plurality of structural bodies, each structural body may have different functions and roles, and the bases formed beneath each structural body may also be different. However, the plurality of structural bodies is derived from films formed in the same layer by the same process and have the same material. Therefore, the plurality of these films is defined as existing in the same layer.

When expressing a mode in which another structure is arranged over a certain structure, in the case where it is simply described as “over”, unless otherwise noted, a case where another structure is arranged directly over a certain structure as if in contact with that structure, and a case where another structure is arranged via yet another structure over a certain structure, are both included.

### First Embodiment

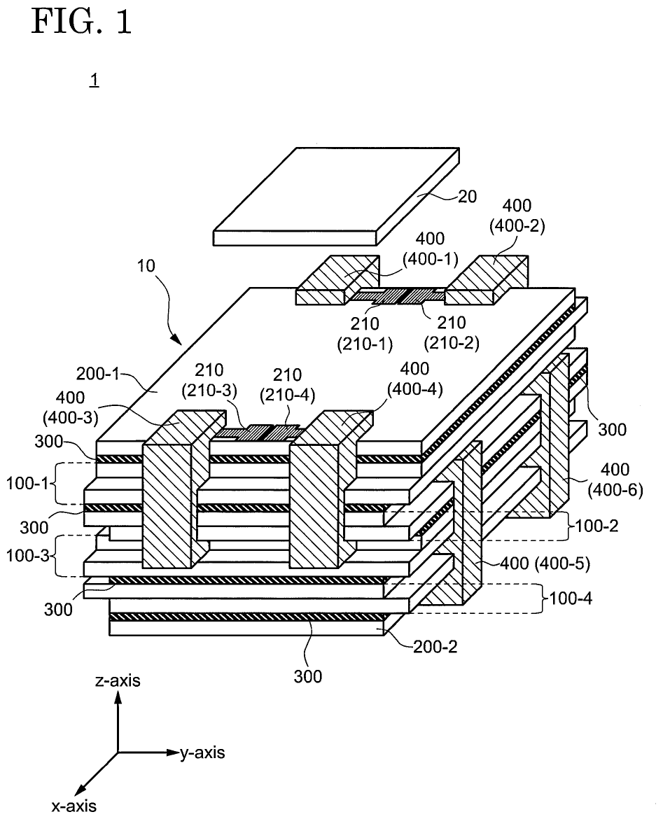

In the present embodiment, a lighting device 1 and an optical element 10 included in the lighting device 1 are described with reference to FIGS. 1 to 13.

### [1. Configuration of Lighting Device 1]

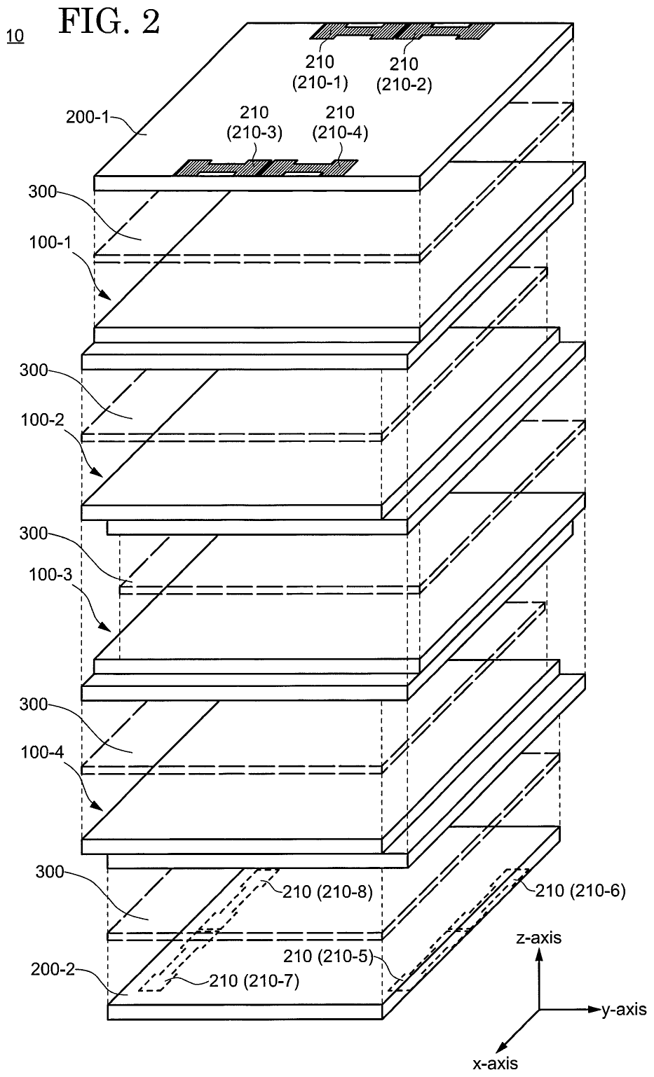

FIG. 1 is a schematic perspective view showing a configuration of the lighting device 1 in the present embodiment. FIG. 2 is a schematic exploded perspective view showing a configuration of the optical element 10 in the present embodiment. Here, an x-axis, a y-axis, and a z-axis are coordinate axes based on the optical element 10. In addition, hereinafter, although the direction indicated by the arrows on the coordinate axes represents a positive (“+”) direction, and the opposite direction represents a negative (“−”) direction, the sign “+” or “−” may not be added when the direction on the axis is not limited to a particular direction.

As shown in FIG. 1, the lighting device 1 includes the optical element 10 and a light source 20. The optical element 10 includes a first liquid crystal cell 100-1, a second liquid crystal cell 100-2, a third liquid crystal cell 100-3, a fourth liquid crystal cell 100-4, a first terminal connection substrate 200-1, and a second terminal connection substrate 200-2. Although the configuration of the optical element 10 is described in detail later, the optical element 10 can change the shape of light passing through the optical element 10, that is, a light distribution, by controlling a diffusion of light emitted from the light source 20. For example, although light emitting diodes (LEDs) can be used for the light source 20, the light source 20 is not limited thereto. The light source 20 may be any element or device that can emit light.

In the optical element 10, the first terminal connection substrate 200-1, the first liquid crystal cell 100-1, the second liquid crystal cell 100-2, the third liquid crystal cell 100-3, the fourth liquid crystal cell 100-4, and the second terminal connection substrate 200-2 are stacked in the z-axis direction in this order from the side closest to the light source 20. That is, the optical element 10 includes four liquid crystal cells 100 between the two terminal connection substrates 200. The four liquid crystal cells 100 overlap each other. The number of liquid crystal cells 100 included in the optical element 10 is not limited to four. The optical element 10 only needs to include at least two liquid crystal cells 100.

An optical elastic resin layer 300 is provided between the first terminal connection substrate 200-1 and the first liquid crystal cell 100-1, between the first liquid crystal cell 100-1 and the second liquid crystal cell 100-2, between the third liquid crystal cell 100-3 and the fourth liquid crystal cell 100-4, or between the fourth liquid crystal cell 100-4 and the second terminal connection substrate 200-2. The optical elastic resin layer 300 can bond and fix two adjacent liquid crystal cells 100, or the terminal connection substrate 200 and the liquid crystal cell 100. For example, an adhesive containing a light transmitting acrylic resin can be used for the optical elastic resin layer 300.

Each of the first terminal connection substrate 200-1 and the second terminal connection substrate 200-2 is a substrate having light transmitting properties. For example, although each of the first terminal connection substrate 200-1 and the second terminal connection substrate 200-2 is a glass substrate, each of the first terminal connection substrate 200-1 and the second terminal connection substrate 200-2 is not limited thereto. Further, a plurality of terminals 210 are provided on each of the first terminal connection substrate 200-1 and the second terminal connection substrate 200-2. Each of the plurality of terminals 210 is provided near a side surface of the optical element 10 and is electrically connected to an inter-cell conductive electrode 400 extending in the z-axis direction.

For example, a conductive adhesive containing a conductive filler can be used for the inter-cell conductive electrode 400. For example, silver or carbon can be used as the conductive filler. The inter-cell conductive electrode 400 can be formed using a dispenser. Specifically, when the dispenser is moved in the z-axis direction while discharging the conductive adhesive from the nozzle of the dispenser, the inter-cell conductive electrode 400 extending in the z-axis direction can be formed on the side surface of the optical element 10. In addition, the conductive adhesive can also be injected into the step formed on the side surface of the optical element 10 by utilizing the capillary phenomenon.

The first liquid crystal cell 100-1 to the fourth liquid crystal cell 100-4 all have the same configuration. That is, in the optical element 10, four liquid crystal cells 100 having the same configuration are stacked with their arrangement directions changed from one another.

### [2. Configuration of Liquid Crystal Cell 100]

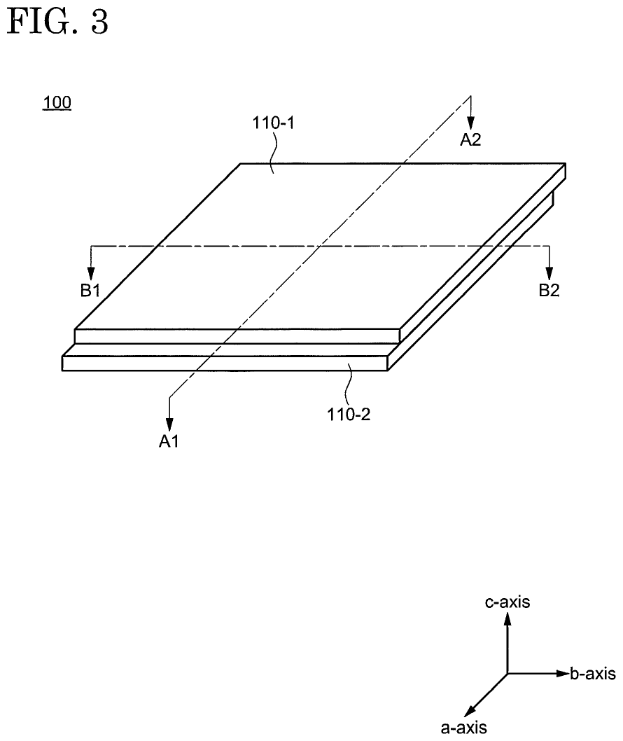

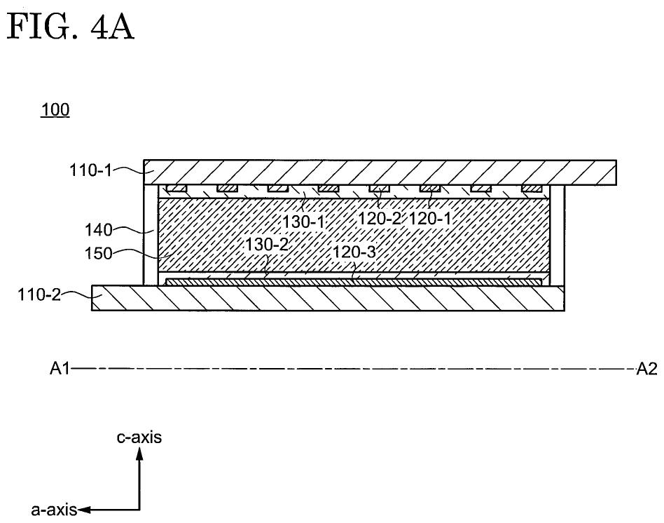

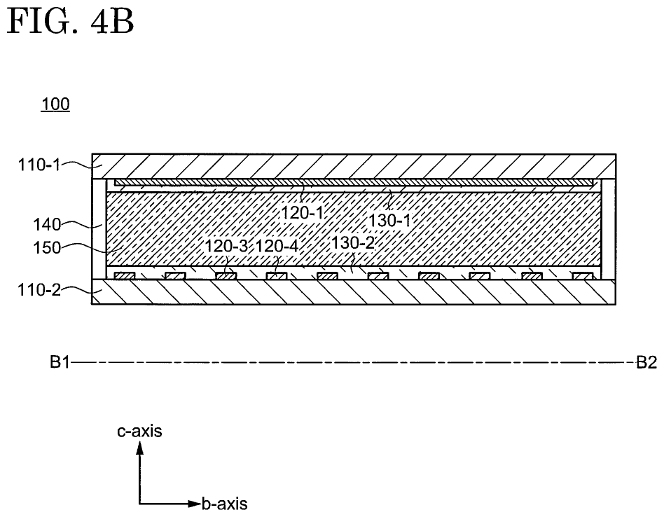

FIG. 3 is a schematic perspective view showing a configuration of the liquid crystal cell 100 included in the optical element 10 in the present embodiment. Each of FIGS. 4A and 4B is a schematic cross-sectional view showing the configuration of the liquid crystal cell 100 included in the optical element 10 in the present embodiment. Specifically, FIG. 4A is a cross-sectional view of the liquid crystal cell 100 in a ca plane cut along a line A1-A2 in FIG. 3, and FIG. 4B is a cross-sectional view of the liquid crystal cell 100 in a bc plane cut along a line B1-B2 in FIG. 3. Here, an a-axis, a b-axis, and a c-axis are coordinate axes based on the liquid crystal cell 100.

As shown in FIG. 3, the liquid crystal cell 100 is configured to bond a first substrate 110-1 and a second substrate 110-2 together. Although the first substrate 110-1 and the second substrate 110-2 do not completely overlap each other, the first substrate 110-1 and the second substrate 110-2 are bonded together such that a part of the surface of the first substrate 110-1 and a part of the surface of the second substrate 110-2 are exposed. Although details are described later, the exposed surfaces of the first substrate 110-1 and the second substrate 110-2 are provided with connection pads that are electrically connected to the inter-cell conductive electrodes 400.

As shown in FIGS. 4A and 4B, the first substrate 110-1 is provided with a plurality of first transparent electrodes 120-1, a plurality of second transparent electrodes 120-2, and a first alignment film 130-1 covering the plurality of first transparent electrodes 120-1 and the plurality of second transparent electrodes 120-2. The first transparent electrodes 120-1 and the second transparent electrodes 120-2 are arranged alternately. Further, the second substrate 110-2 is provided with a plurality of third transparent electrodes 120-3, a plurality of fourth transparent electrodes 120-4, and a second alignment film 130-2 covering the plurality of third transparent electrodes 120-3 and the plurality of fourth transparent electrodes 120-4. The third transparent electrodes 120-3 and the fourth transparent electrodes 120-4 are arranged alternately. The first substrate 110-1 and the second substrate 110-2 are disposed such that the first transparent electrodes 120-1 and the second transparent electrodes 120-2 face the third transparent electrodes 120-3 and the fourth transparent electrodes 120-4, and are bonded to each other via a sealing member 140 provided on the periphery of the first substrate 110-1 and the second substrate 110-2. A liquid crystal is sealed in a space surrounded by the first substrate 110-1 (more specifically, the first alignment film 130-1), the second substrate 110-2 (more specifically, the second alignment film 130-2), and the sealing member 140. A liquid crystal layer 150 is provided between the first substrate 110-1 and the second substrate 110-2.

For example, a rigid substrate having light-transmitting properties such as a glass substrate, a quartz substrate, or a sapphire substrate is used as each of the first substrate 110-1 and the second substrate 110-2. Further, a flexible substrate having light-transmitting properties such as a polyimide resin substrate, an acrylic resin substrate, a siloxane resin substrate, or a fluorine resin substrate can also be used as each of the first substrate 110-1 and the second substrate 110-2.

Each of the first transparent electrode 120-1, the second transparent electrode 120-2, the third transparent electrode 120-3, and the fourth transparent electrode 120-4 functions as an electrode for forming an electric field in the liquid crystal layer 150. For example, a transparent conductive material such as indium tin oxide (ITO) or indium zinc oxide (IZO) is used for each of the first transparent electrode 120-1, the second transparent electrode 120-2, the third transparent electrode 120-3, and the fourth transparent electrode 120-4. Further, a non-transparent metal material is used for each of the first transparent electrode 120-1, the second transparent electrode 120-2, the third transparent electrode 120-3, and the fourth transparent electrode 120-4.

The liquid crystal layer 150 can refract transmitted light or change the polarization state of transmitted light in accordance with the alignment state of the liquid crystal molecules. For example, nematic liquid crystal can be used as the liquid crystal of the liquid crystal layer 150. Although a positive liquid crystal is described as the liquid crystal in the present embodiment, a negative liquid crystal can also be adopted by changing the initial alignment directions of the liquid crystal molecules. Further, the liquid crystal preferably contains a chiral agent that imparts twist to the liquid crystal molecules.

Each of the first alignment film 130-1 and the second alignment film 130-2 aligns the liquid crystal molecules in the liquid crystal layer 150 in a predetermined direction. For example, a polyimide resin or the like can be used for each of the first alignment film 130-1 and the second alignment film 130-2. In addition, each of the first alignment film 130-1 and the second alignment film 130-2 may be imparted with alignment properties by an alignment treatment such as a rubbing method or a photo-alignment method. The rubbing method is a method of rubbing the surface of the alignment film in one direction. The photo-alignment method is a method of irradiating an alignment film with linearly polarized ultraviolet rays.

A rubbing treatment is performed on the first alignment film 130-1 in the a-axis direction, and the first alignment film 130-1 has an alignment characteristic that aligns the long axes of the liquid crystal molecules on the side of the first substrate 110-1 of the liquid crystal layer 150 in the a-axis direction. Further, a rubbing treatment is performed on the second alignment film 130-2 in the b-axis direction, and the second alignment film 130-2 has an alignment characteristic that aligns the long axes of the liquid crystal molecules on the side of the second substrate 110-2 of the liquid crystal layer 150 in the b-axis direction.

An adhesive material containing epoxy resin, acrylic resin, or the like can be used for the sealing member 140. The adhesive material may be an ultraviolet curable type or a heat curable type.

### [3. Electrode Pattern of Liquid Crystal Cell 100]

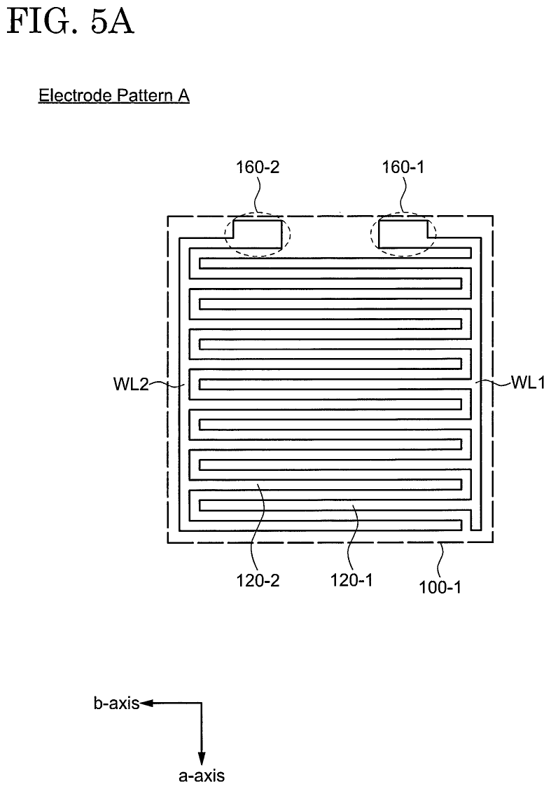

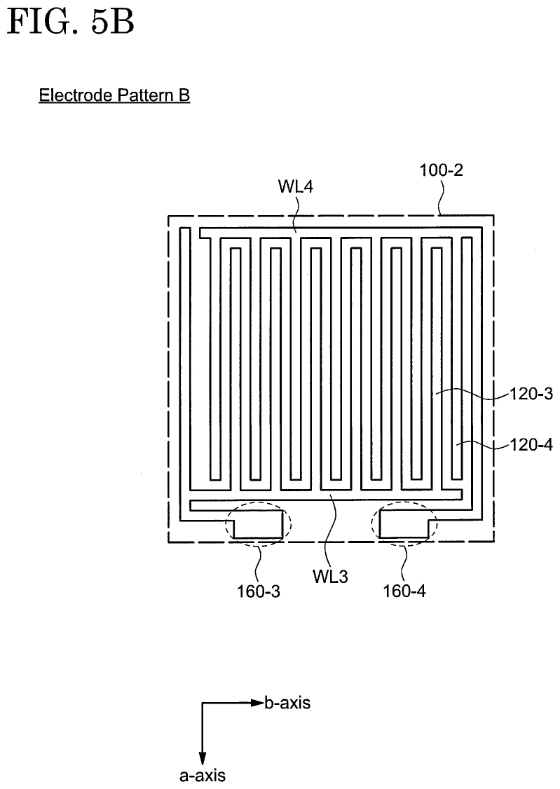

Each of FIGS. 5A and 5B is a schematic plan view illustrating electrode patterns of the liquid crystal cell 100 included in the optical element 10 in the present embodiment. Specifically, FIG. 5A is a plan view showing an electrode pattern A formed on the first substrate 110-1, and FIG. 5B is a plan view showing an electrode pattern B formed on the second substrate 110-2.

As shown in FIG. 5A, the electrode pattern A includes the plurality of first transparent electrodes 120-1 and the plurality of second transparent electrodes 120-2 extending in the b-axis direction. The plurality of first transparent electrodes 120-1 and the plurality of second transparent electrodes 120-2 are arranged in a comb-tooth shape. The electrode pattern A also includes a first connection pad 160-1 and a second connection pad 160-2 provided on the periphery of the first substrate 110-1. The plurality of first transparent electrodes 120-1 are electrically connected to the first connection pad 160-1 via a wiring WL1. The plurality of second transparent electrodes 120-2 are also electrically connected to the second connection pad 160-2 via a wiring WL2.

As shown in FIG. 5B, the electrode pattern B includes the plurality of third transparent electrodes 120-3 and the plurality of fourth transparent electrodes 120-4 extending in the a-axis direction. The plurality of third transparent electrodes 120-3 and the plurality of fourth transparent electrodes 120-4 are arranged in a comb-tooth shape. The electrode pattern B also includes a third connection pad 160-3 and a fourth connection pad 160-4 provided on the periphery of the second substrate 110-2. The plurality of third transparent electrodes 120-3 are electrically connected to the third connection pad 160-3 via a wiring WL3. The plurality of fourth transparent electrodes 120-4 are electrically connected to the fourth connection pad 160-4 via a wiring WL4.

The first substrate 110-1 and the second substrate 110-2 are bonded to each other with a shift in the a-axis direction (see FIG. 3). As a result, at least a part of the first connection pad 160-1 and at least a part of the second connection pad 160-2 on the first substrate 110-1 are exposed from the second substrate 110-2. Similarly, at least a part of the third connection pad 160-3 and at least a part of the fourth connection pad 160-4 on the second substrate 110-2 are exposed from the first substrate 110-1. The inter-cell conductive electrode 400 is connected to each of the exposed first connection pad 160-1 to fourth connection pad 160-4. Therefore, in each of the first liquid crystal cell 100-1 to the fourth liquid crystal cell 100-4, a voltage can be supplied to the first transparent electrode 120-1, the second transparent electrode 120-2, the third transparent electrode 120-3, and the fourth transparent electrode 120-4 via the four inter-cell conductive electrodes 400, thereby controlling the liquid crystal in the liquid crystal layer 150.

### [4. Optical Characteristics of Liquid Crystal Cell 100]

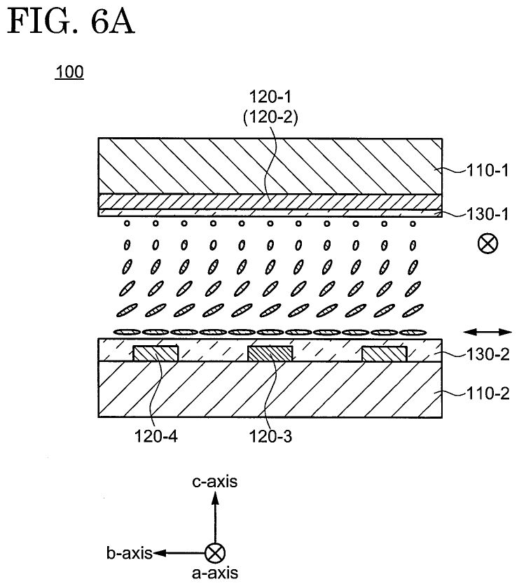

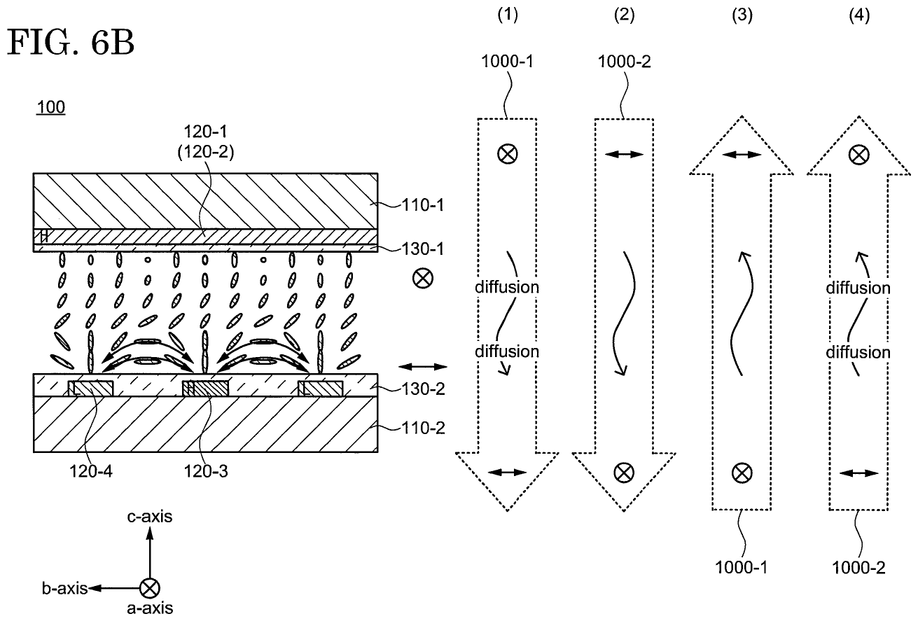

Each of FIGS. 6A and 6B is a schematic diagram illustrating optical characteristics of the liquid crystal cell 100 in the present embodiment. Specifically, FIG. 6A shows the liquid crystal cell 100 in a state where no voltage is applied to the transparent electrodes 120, and FIG. 6B shows the liquid crystal cell 100 in a state where voltages are applied to the transparent electrodes 120.

As shown in FIG. 6A, the liquid crystal molecules on the side of the first substrate 110-1 of the liquid crystal layer 150 are aligned in the a-axis direction (i.e., the initial alignment direction of the liquid crystal molecules is the a-axis), and the liquid crystal molecules on the side of the second substrate 110-2 of the liquid crystal layer 150 are aligned in the b-axis direction (i.e., the initial alignment direction of the liquid crystal molecules is the b-axis). Therefore, in a state where no voltage is applied to any of the first transparent electrode 120-1 to the fourth transparent electrode 120-4, the liquid crystal molecules in the liquid crystal layer 150 are aligned so as to be twisted 90 degrees along the c-axis direction as they move from the first substrate 110-1 to the second substrate 110-2. Further, the polarization plane (the direction of the polarization axis or the polarization component) of the light passing through the liquid crystal layer 150 is rotated 90 degrees in accordance with the alignment direction of the liquid crystal molecules. In other words, the light passing through the liquid crystal layer 150 has optical rotation.

On the other hand, when voltages are applied so that a potential difference is generated between two adjacent transparent electrodes 120, an electric field (hereinafter referred to as a “lateral electric field”) is generated between the two adjacent transparent electrodes 120, and the alignment state of the liquid crystal molecules changes. As shown in FIG. 6B, the liquid crystal molecules in the liquid crystal layer 150 are aligned so as to be twisted 90 degrees along the c-axis direction from the first substrate 110-1 to the second substrate 110-2, while the liquid crystal molecules closer to the first substrate 110-1 are aligned in a convex arc shape with respect to the first substrate 110-1 by the lateral electric field between the first transparent electrode 120-1 and the second transparent electrode 120-2, and the liquid crystal molecules closer to the second substrate 110-2 are aligned in a convex arc shape with respect to the second substrate 110-2 by the lateral electric field between the third transparent electrode 120-3 and the fourth transparent electrode 120-4. The liquid crystal molecules aligned on the convex arc have a refractive index distribution, and light having the same polarization direction as the alignment direction of the liquid crystal molecules is diffused. In addition, since the cell gap d, which is the distance between the first substrate 110-1 and the second substrate 110-2, is sufficiently larger than the distance between two adjacent transparent electrodes (for example, 10 μm≤d≤30 μm), the alignment state of the liquid crystal molecules located in the vicinity of the center between the first substrate 110-1 and the second substrate 110-2 hardly changes.

The light emitted from the light source 20 shown in FIG. 1 includes a polarized component in the x-axis direction (hereinafter, referred to as a “P-polarization component”) and a polarized component in the y-axis direction (hereinafter, referred to as an “S-polarization component”). However, in the following description, the light emitted from the light source 20 is described as being divided into a first light 1000-1 having the P-polarization component and a second light 1000-2 having the S-polarization component, for convenience. Further, the x-axis direction and the y-axis direction are described as corresponding to the a-axis direction and the b-axis direction, respectively, for convenience.

Since the polarization direction of the P-polarization component of the first light 1000-1 incident on the first substrate 110-1 is the same as the alignment direction of the liquid crystal molecules on the side of the first substrate 110-1, the first light 1000-1 is diffused in the a-axis direction in accordance with the refractive index distribution of the liquid crystal molecules (see FIG. 6B(1)). Further, the first light 1000-1 is rotated while passing through the liquid crystal layer 150, and the polarization component changes from the P-polarization component to the S-polarization component. Since the polarization direction of the S-polarization component of the first light 1000-1 is the same as the alignment direction of the liquid crystal molecules on the side of the second substrate 110-2, the first light 1000-1 is diffused in the b-axis direction in accordance with the refractive index distribution of the liquid crystal molecules.

Since the polarization direction of the S-polarization component of the second light 1000-2 incident on the first substrate 110-1 is different from the alignment direction of the liquid crystal molecules on the side of the first substrate 110-1, the second light 1000-2 is not diffused (see FIG. 6B(2)). Further, the second light 1000-2 is rotated while passing through the liquid crystal layer 150, and the polarization component changes from the S-polarization component to the P-polarization component. Since the polarization direction of the P-polarization component of the second light 1000-2 is different from the alignment direction of the liquid crystal molecules on the side of the second substrate 110-2, the second light 1000-2 is not diffused.

Since the polarization direction of the P-polarization component of the first light 1000-1 incident on the second substrate 110-2 is different from the alignment direction of the liquid crystal molecules on the side of the second substrate 110-2, the first light 1000-1 is not diffused (see FIG. 6B(3)). Further, the second light 1000-2 is rotated while passing through the liquid crystal layer 150, and the polarization component changes from the P-polarization component to the S-polarization component. Since the polarization direction of the S-polarization component of the first light 1000-1 is different from the alignment direction of the liquid crystal molecules on the side of the first substrate 110-1, the first light 1000-1 is not diffused.

Since the polarization direction of the S-polarization component of the second light 1000-2 incident on the second substrate 110-2 is the same as the alignment direction of the liquid crystal molecules on the side of the second substrate 110-2, the second light 1000-2 is diffused in the b-axis direction in accordance with the refractive index distribution of the liquid crystal molecules (see FIG. 6B(4)). Further, the second light 1000-2 is rotated while passing through the liquid crystal layer 150, and the polarization component changes from the S-polarization component to the P-polarization component. Since the polarization direction of the S-polarization component of the first light 1000-1 is the same as the alignment direction of the liquid crystal molecules on the side of the second substrate 110-2, the first light 1000-1 is diffused in the b-axis direction in accordance with the refractive index distribution of the liquid crystal molecules.

In the above description, an example is described in which light is diffused on both sides of the first substrate 110-1 and the second substrate 110-2. However, when voltages are applied to the transparent electrodes 120 on one substrate 110 and no voltage is applied to the transparent electrodes 120 on the other substrate 110, light can also be diffused only on the side of the one substrate 110.

### [5. Electrical Connection Configuration of Optical Element 10]

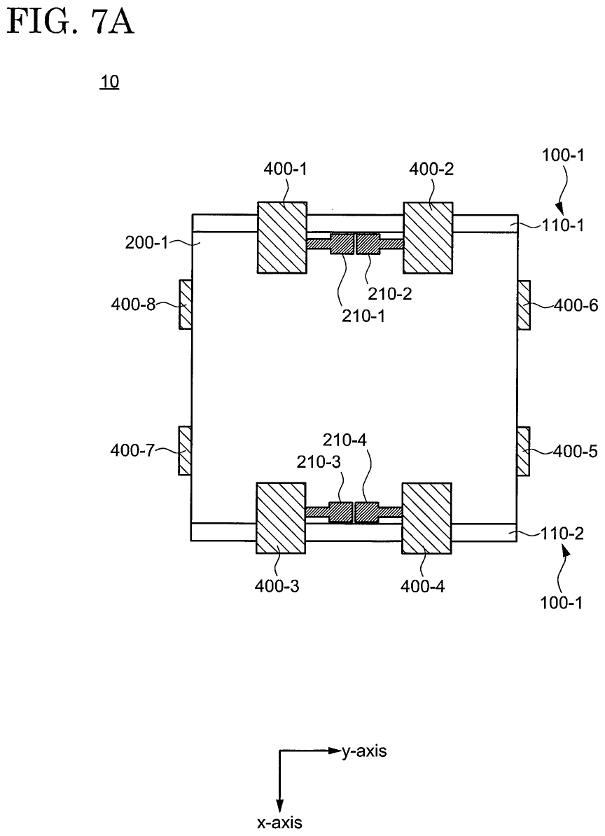

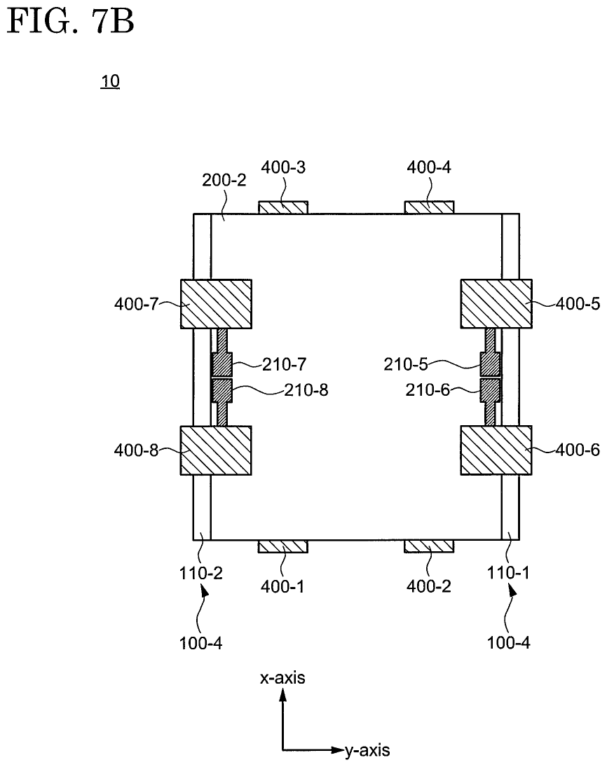

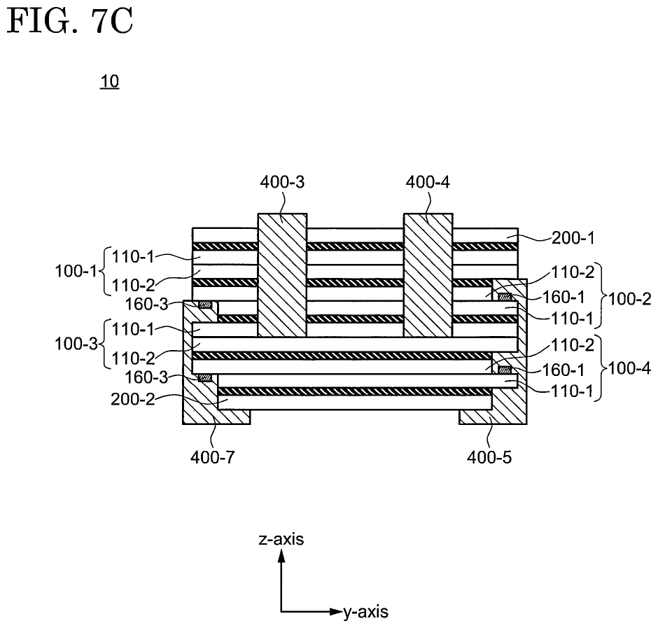

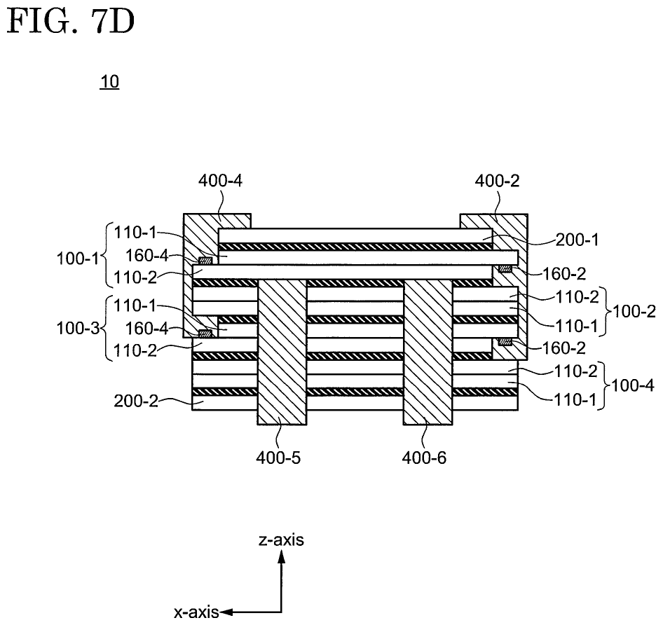

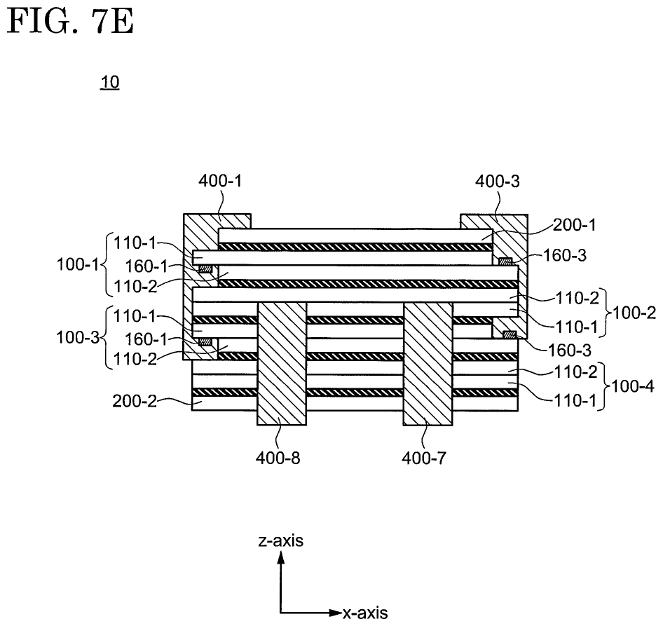

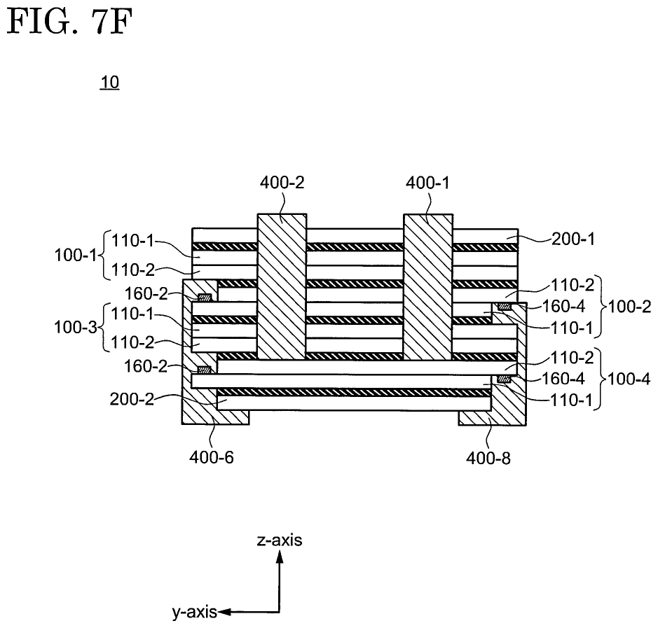

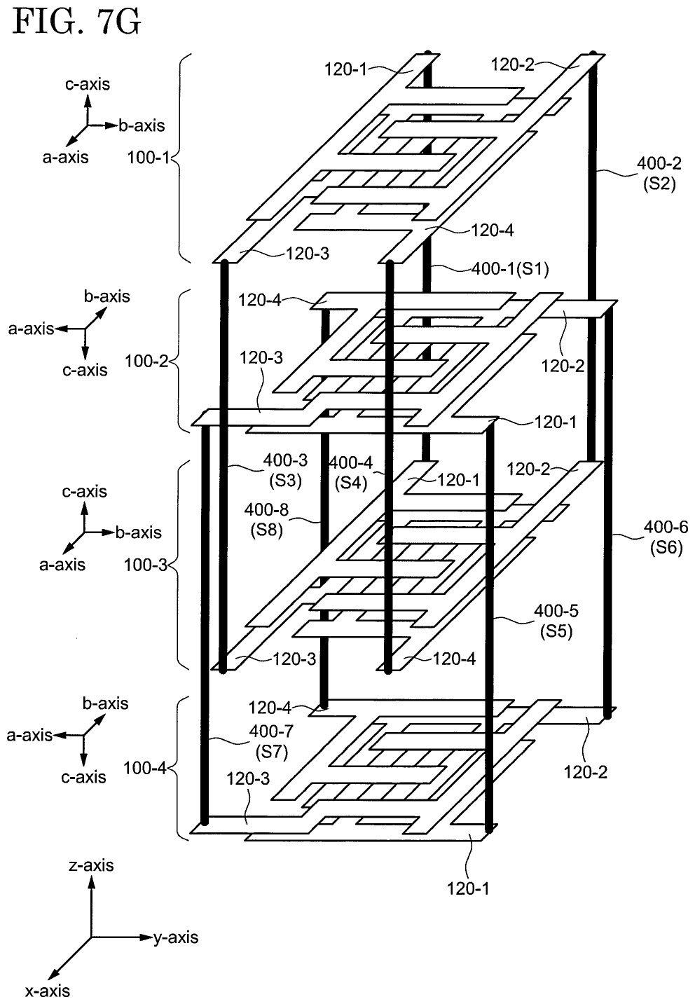

FIGS. 7A to 7F are plan views illustrating a configuration of electrical connections of the optical element 10 in the present embodiment. Specifically, FIGS. 7A to 7F respectively show a top view, a bottom view, a front view, a right side view, a left side view, and a back view of the optical element 10. Further, FIG. 7G is a schematic perspective view illustrating a configuration of electrical connections of the optical element 10 in the present embodiment. Specifically, FIG. 7G shows the electrical connections of the transparent electrodes 120 of each liquid crystal cell 100 in the optical element 10.

First, the arrangement directions of the first liquid crystal cell 100-1 to the fourth liquid crystal cell 100-4 are described with reference to FIGS. 7A to 7G. The first liquid crystal cell 100-1 is arranged so that the +a-axis direction, the +b-axis direction, and the +c-axis direction of the liquid crystal cell 100 correspond to the +x-axis direction, the +y-axis direction, and the +z-axis direction of the optical element 10, respectively. The second liquid crystal cell 100-2 is arranged so that the +a-axis direction, the +b-axis direction, and the +c-axis direction of the liquid crystal cell 100 correspond to the −y-axis direction, the −x-axis direction, and the −z-axis direction of the optical element 10, respectively. The third liquid crystal cell 100-3 is arranged so that the +a-axis direction, the +b-axis direction, and the +c-axis direction of the liquid crystal cell 100 correspond to the +x-axis direction, the +y-axis direction, and the +z-axis direction of the optical element 10, respectively. The fourth liquid crystal cell 100-4 is arranged such that the +a-axis direction, the +b-axis direction, and the +c-axis direction of the liquid crystal cell 100 correspond to the −y-axis direction, the −x-axis direction, and the −z-axis direction of the optical element 10, respectively. In this case, the second substrate 110-2 of the first liquid crystal cell 100-1 and the second substrate 110-2 of the second liquid crystal cell 100-2 face each other, the first substrate 110-1 of the second liquid crystal cell 100-2 and the first substrate 110-1 of the third liquid crystal cell 100-3 face each other, and the second substrate 110-2 of the third liquid crystal cell 100-3 and the second substrate 110-2 of the fourth liquid crystal cell 100-4 face each other.

In other words, the arrangement directions of the third liquid crystal cell 100-3 and the fourth liquid crystal cell 100-4 are the same as the arrangement directions of the first liquid crystal cell 100-1 and the second liquid crystal cell 100-2, respectively. The arrangement direction of the second liquid crystal cell 100-2 is the same as the arrangement direction of the first liquid crystal cell 100-1 turned upside down and rotated by 90 degrees. Similarly, the arrangement direction of the fourth liquid crystal cell is the same as the arrangement direction of the third liquid crystal cell 100-3 turned upside down and rotated by 90 degrees. As shown in FIGS. 7A and 7B, the planar shape of the liquid crystal cell 100 is approximately square, and the corners of the first liquid crystal cell 100-1 to the fourth liquid crystal cell 100-4 are approximately aligned in a plan view.

Although details are described later, in the optical element 10 including the first liquid crystal cell 100-1 to the fourth liquid crystal cell 100-4 having the arrangement directions described above, the first liquid crystal cell 100-1 and the third liquid crystal cell 100-3 can control the diffusion of the P-polarization component of the light, and the second liquid crystal cell 100-2 and the fourth liquid crystal cell 100-4 can control the diffusion of the S-polarization component of the light.

Next, the configuration of the electrical connections of the optical element 10 is described with reference to FIGS. 7A to 7G.

A third inter-cell conductive electrode 400-3 and a fourth inter-cell conductive electrode 400-4 are provided on a first side surface (front surface) of the optical element 10. A fifth inter-cell conductive electrode 400-5 and a sixth inter-cell conductive electrode 400-6 are provided on a second side surface (right side surface) of the optical element 10. A seventh inter-cell conductive electrode 400-7 and an eighth inter-cell conductive electrode 400-8 are provided on a third side surface (left side surface) of the optical element 10. A first inter-cell conductive electrode 400-1 and a second inter-cell conductive electrode 400-2 are provided on a fourth side surface (back surface) of the optical element 10.

The first inter-cell conductive electrode 400-1 is electrically connected to the first terminal 210-1 on the first terminal connection substrate 200-1. The first inter-cell conductive electrode 400-1 is also electrically connected to the first connection pad 160-1 of the first liquid crystal cell 100-1 and the first connection pad 160-1 of the third liquid crystal cell 100-3. Therefore, the first terminal 210-1 is electrically connected to the first transparent electrode 120-1 of the first liquid crystal cell 100-1 and the first transparent electrode 120-1 of the third liquid crystal cell 100-3 via the first inter-cell conductive electrode 400-1.

The second inter-cell conductive electrode 400-2 is electrically connected to the second terminal 210-2 on the first terminal connection substrate 200-1. The second inter-cell conductive electrode 400-2 is also electrically connected to the second connection pad 160-2 of the first liquid crystal cell 100-1 and the second connection pad 160-2 of the third liquid crystal cell 100-3. Therefore, the second terminal 210-2 is electrically connected to the second transparent electrode 120-2 of the first liquid crystal cell 100-1 and the second transparent electrode 120-2 of the third liquid crystal cell 100-3 via the second inter-cell conductive electrode 400-2.

The third inter-cell conductive electrode 400-3 is electrically connected to the third terminal 210-3 on the first terminal connection substrate 200-1. The third inter-cell conductive electrode 400-3 is also electrically connected to the third connection pad 160-3 of the first liquid crystal cell 100-1 and the third connection pad 160-3 of the third liquid crystal cell 100-3. Therefore, the third terminal 210-3 is electrically connected to the third transparent electrode 120-3 of the first liquid crystal cell 100-1 and the third transparent electrode 120-3 of the third liquid crystal cell 100-3 via the third inter-cell conductive electrode 400-3.

The fourth inter-cell conductive electrode 400-4 is electrically connected to the fourth terminal 210-4 on the first terminal connection substrate 200-1. The fourth inter-cell conductive electrode 400-4 is also electrically connected to the fourth connection pad 160-4 of the first liquid crystal cell 100-1 and the fourth connection pad 160-4 of the third liquid crystal cell 100-3. Therefore, the fourth terminal 210-4 is electrically connected to the fourth transparent electrode 120-4 of the first liquid crystal cell 100-1 and the fourth transparent electrode 120-4 of the third liquid crystal cell 100-3 via the fourth inter-cell conductive electrode 400-4.

The fifth inter-cell conductive electrode 400-5 is electrically connected to the fifth terminal 210-5 on the second terminal connection substrate 200-2. The fifth inter-cell conductive electrode 400-5 is also electrically connected to the first connection pad 160-1 of the second liquid crystal cell 100-2 and the first connection pad 160-1 of the fourth liquid crystal cell 100-4. Therefore, the fifth terminal 210-5 is electrically connected to the first transparent electrode 120-1 of the second liquid crystal cell 100-2 and the first transparent electrode 120-1 of the fourth liquid crystal cell 100-4 via the fifth inter-cell conductive electrode 400-5.

The sixth inter-cell conductive electrode 400-6 is electrically connected to the sixth terminal 210-6 on the second terminal connection substrate 200-2. The sixth inter-cell conductive electrode 400-6 is also electrically connected to the second connection pad 160-2 of the second liquid crystal cell 100-2 and the second connection pad 160-2 of the fourth liquid crystal cell 100-4. Therefore, the sixth terminal 210-6 is electrically connected to the second transparent electrode 120-2 of the second liquid crystal cell 100-2 and the second transparent electrode 120-2 of the fourth liquid crystal cell 100-4 via the sixth inter-cell conductive electrode 400-6.

The seventh inter-cell conductive electrode 400-7 is electrically connected to the seventh terminal 210-7 on the second terminal connection substrate 200-2. The seventh inter-cell conductive electrode 400-7 is also electrically connected to the third connection pad 160-3 of the second liquid crystal cell 100-2 and the third connection pad 160-3 of the fourth liquid crystal cell 100-4. Therefore, the seventh terminal 210-7 is electrically connected to the third transparent electrode 120-3 of the second liquid crystal cell 100-2 and the third transparent electrode 120-3 of the fourth liquid crystal cell 100-4 via the seventh inter-cell conductive electrode 400-7.

The eighth inter-cell conductive electrode 400-8 is electrically connected to the eighth terminal 210-8 on the second terminal connection substrate 200-2. The eighth inter-cell conductive electrode 400-8 is also electrically connected to the fourth connection pad 160-4 of the second liquid crystal cell 100-2 and the fourth connection pad 160-4 of the fourth liquid crystal cell 100-4. Therefore, the eighth terminal 210-8 is electrically connected to the fourth transparent electrode 120-4 of the second liquid crystal cell 100-2 and the fourth transparent electrode 120-4 of the fourth liquid crystal cell 100-4 via the eighth inter-cell conductive electrode 400-8.

As described above, the inter-cell conductive electrode 400 electrically connects two connection pads 160 included in two different liquid crystal cells 100 to each other, and also electrically connects the two connection pads 160 to the terminal 210. Thus, it is possible to simultaneously apply a voltage corresponding to a signal to two transparent electrodes 120 included in two different liquid crystal cells 100 by simply inputting the signal to one terminal 210.

Specifically, as shown in FIG. 7G, the first signal S1 input to the first terminal 210-1 is input to the first transparent electrode 120-1 of each of the first liquid crystal cell 100-1 and the third liquid crystal cell 100-3 via the first inter-cell conductive electrode 400-1. The second signal S2 input to the second terminal 210-2 is input to the second transparent electrode 120-2 of each of the first liquid crystal cell 100-1 and the third liquid crystal cell 100-3 via the second inter-cell conductive electrode 400-2. The third signal S3 input to the third terminal 210-3 is input to the third transparent electrode 120-3 of each of the first liquid crystal cell 100-1 and the third liquid crystal cell 100-3 via the third inter-cell conductive electrode 400-3. The fourth signal S4 input to the fourth terminal 210-4 is input to the fourth transparent electrodes 120-4 of the first liquid crystal cell 100-1 and the third liquid crystal cell 100-3 via the fourth inter-cell conductive electrode 400-4. The fifth signal S5 input to the fifth terminal 210-5 is input to the first transparent electrodes 120-1 of the second liquid crystal cell 100-2 and the fourth liquid crystal cell 100-4 via the fifth inter-cell conductive electrode 400-5. The sixth signal S6 input to the sixth terminal 210-6 is input to the second transparent electrodes 120-2 of the second liquid crystal cell 100-2 and the fourth liquid crystal cell 100-4 via the sixth inter-cell conductive electrode 400-6. The seventh signal S7 input to the seventh terminal 210-7 is input to the third transparent electrodes 120-3 of the second liquid crystal cell 100-2 and the fourth liquid crystal cell 100-4 via the seventh inter-cell conductive electrode 400-7. The eighth signal S8 input to the eighth terminal 210-8 is input to the fourth transparent electrodes 120-4 of the second liquid crystal cell 100-2 and the fourth liquid crystal cell 100-4 via the eighth inter-cell conductive electrode 400-8.

### [6. Light Distribution Control of Optical Element 10]

The optical element 10 can control the light distribution to have various shapes by inputting signals to the terminals 210. In the following description, the first signal S1 to the eighth signal S8 input to the first terminal 210-1 to the eighth terminal 210-8, respectively, are described. In addition, although, an intermediate voltage between a high voltage and a low voltage is described as 0V, for convenience, the value of the intermediate voltage is not limited to 0V. For example, when the high voltage and the low voltage are 30V and 0V, respectively, the intermediate voltage may be 15V.

### [6-1. Linear Shape Spreading in X-axis Direction]

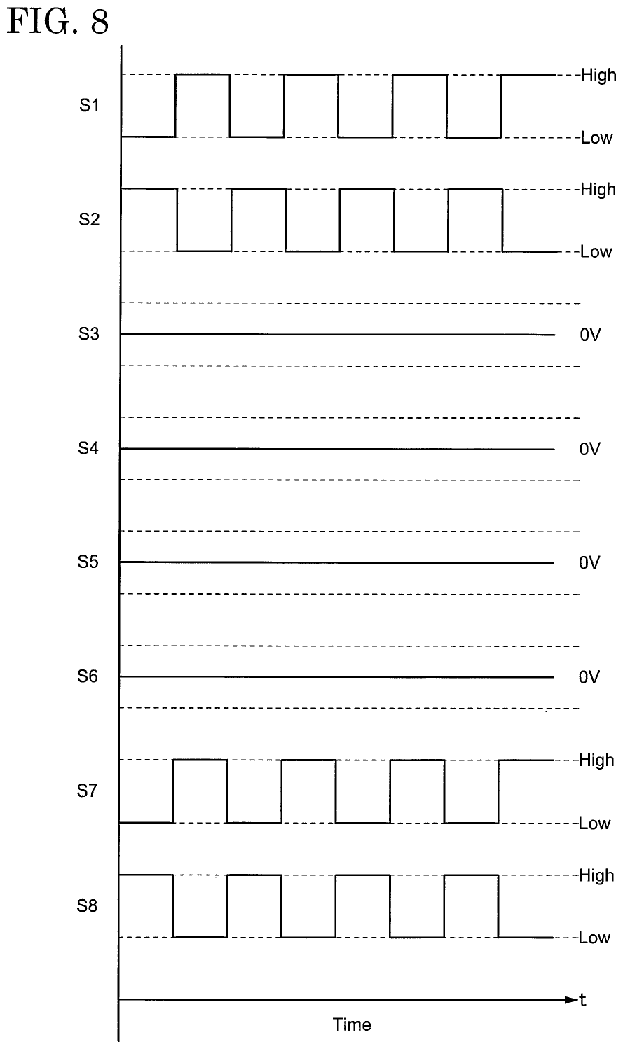

FIG. 8 is a timing chart showing signals input to the optical element 10 to control the light distribution having a linear shape in the x-axis direction in the present embodiment.

As shown in FIG. 8, each of the first signal S1, the second signal S2, the seventh signal S7, and the eighth signal S8 has an AC rectangular wave in which the high voltage and the low voltage are alternately repeated. However, the first signal S1 and the second signal S2 have inverted phases, and the seventh signal S7 and the eighth signal S8 have inverted phases. Further, each of the third signal S3 to the sixth signal S6 is 0V. In this case, the first signal S1 and the second signal S2 generate a lateral electric field in the x-axis direction between the first transparent electrode 120-1 and the second transparent electrode 120-2 of each of the first liquid crystal cell 100-1 and the third liquid crystal cell 100-3. Therefore, the P-polarization component of the light emitted from the light source 20 is diffused only in the x-axis direction in the first liquid crystal cell 100-1 and the third liquid crystal cell 100-3. Further, the seventh signal S7 and the eighth signal S8 generate a lateral electric field in the x-axis direction between the third transparent electrode 120-3 and the fourth transparent electrode 120-4 of each of the second liquid crystal cell 100-2 and the fourth liquid crystal cell 100-4. Therefore, the S-polarization component of the light emitted from the light source 20 is diffused only in the x-axis direction in the second liquid crystal cell 100-2 and the fourth liquid crystal cell 100-4. Accordingly, since the light is diffused in the x-axis direction in each of the first liquid crystal cell 100-1 to the fourth liquid crystal cell 100-4, the light passing through the optical element 10 has a linear shape spreading in the x-axis direction. The diffusion width in the x-axis direction (light distribution angle in the x-axis direction) can be controlled by adjusting the potential difference between the high voltage and the low voltage. For example, when the potential difference increases, the diffusion width in the x-axis direction increases.

### [6-2. Linear Shape Spreading in Y-axis Direction]

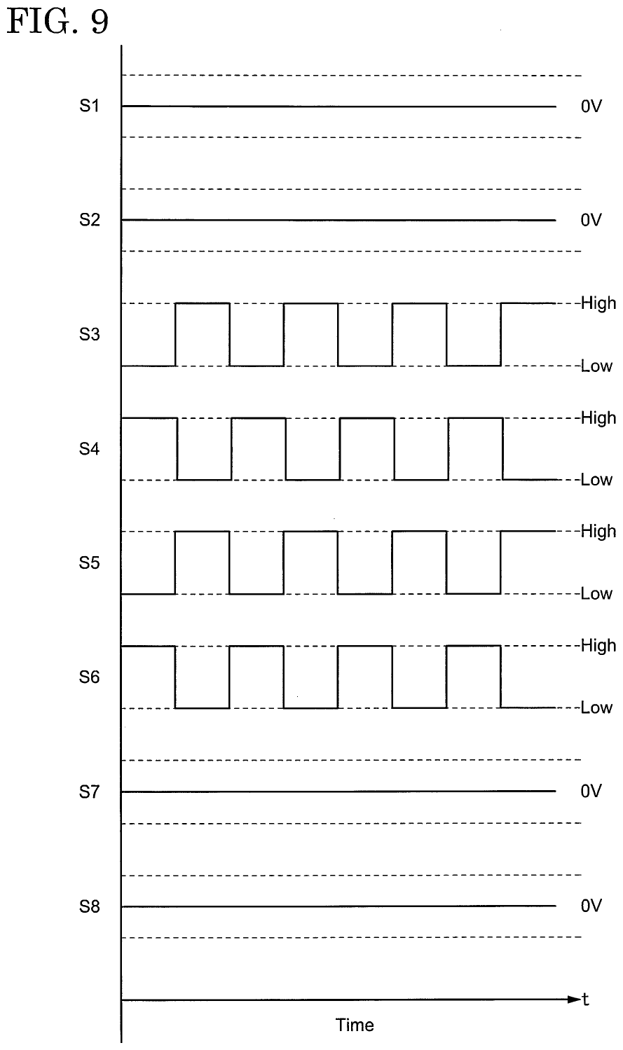

FIG. 9 is a timing chart showing signals input to the optical element 10 to control the light distribution having a linear shape in the y-axis direction in the present embodiment.

As shown in FIG. 9, each of the third signal S3 to the sixth signal S6 has an AC rectangular wave in which a high voltage and a low voltage are alternately repeated. However, the third signal S3 and the fourth signal S4 have inverted phases, and the fifth signal S5 and the sixth signal S6 have inverted phases. Further, each of the first signal S1, the second signal S2, the seventh signal S7, and the eighth signal S8 is 0V. In this case, the third signal S3 and the fourth signal S4 generate a lateral electric field in the y-axis direction between the third transparent electrode 120-3 and the fourth transparent electrode 120-4 of each of the first liquid crystal cell 100-1 and the third liquid crystal cell 100-3. Therefore, the P-polarization component of the light emitted from the light source 20 is diffused only in the y-axis direction in the first liquid crystal cell 100-1 and the third liquid crystal cell 100-3. Further, the fifth signal S5 and the sixth signal S6 generate a lateral electric field in the y-axis direction between the first transparent electrode 120-1 and the second transparent electrode 120-2 of each of the second liquid crystal cell 100-2 and the fourth liquid crystal cell 100-4. Therefore, the S-polarization component of the light emitted from the light source 20 is diffused only in the y-axis direction in the second liquid crystal cell 100-2 and the fourth liquid crystal cell 100-4. Accordingly, since the light is diffused in the y-axis direction in each of the first liquid crystal cell 100-1 to the fourth liquid crystal cell 100-4, the light passing through the optical element 10 has a linear shape spreading in the y-axis direction. The diffusion width in the y-axis direction (light distribution angle in the y-axis direction) can be controlled by adjusting the potential difference between the high voltage and the low voltage. For example, when the potential difference increases, the diffusion width in the y-axis direction increases.

### [6-3. Circular Shape]

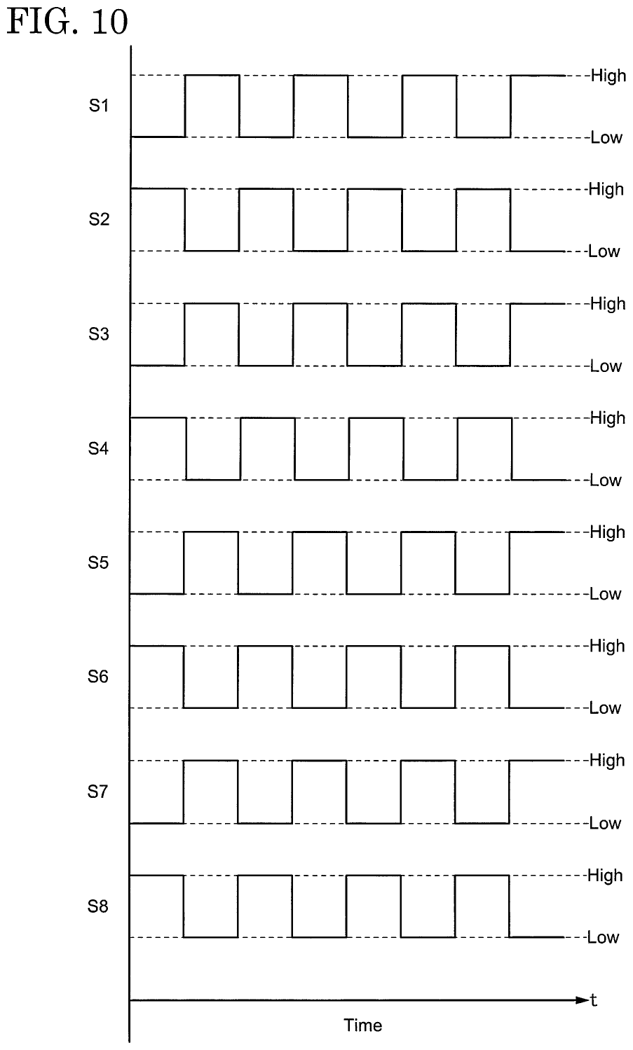

FIG. 10 is a timing chart showing signals input to the optical element 10 to control the light distribution having a circular shape in the present embodiment.

As shown in FIG. 10, each of the first signal S1 to the eighth signal S8 has an AC rectangular wave in which a high voltage and a low voltage are alternately repeated. However, the first signal S1 and the second signal have inverted phases, the third signal S3 and the fourth signal S4 have inverted phases, the fifth signal S5 and the sixth signal S6 have inverted phases, and the seventh signal S7 and the eighth signal S8 have inverted phases. In this case, the first signal S1 and the second signal S2 generate a lateral electric field in the x-axis direction between the first transparent electrode 120-1 and the second transparent electrode 120-2 of each of the first liquid crystal cell 100-1 and the third liquid crystal cell 100-3. Further, the third signal S3 and the fourth signal S4 generate a lateral electric field in the y-axis direction between the third transparent electrode 120-3 and the fourth transparent electrode 120-4 of each of the first liquid crystal cell 100-1 and the third liquid crystal cell 100-3. Therefore, the P-polarization component of the light emitted from the light source 20 is diffused not only in the x-axis direction but also in the y-axis direction in the first liquid crystal cell 100-1 and the third liquid crystal cell 100-3. Further, the fifth signal S5 and the sixth signal S6 generate a lateral electric field in the y-axis direction between the first transparent electrode 120-1 and the second transparent electrode 120-2 of each of the second liquid crystal cell 100-2 and the fourth liquid crystal cell 100-4. Furthermore, the seventh signal S7 and the eighth signal S8 generate a lateral electric field in the x-axis direction between the third transparent electrode 120-3 and the fourth transparent electrode 120-4 of each of the second liquid crystal cell 100-2 and the fourth liquid crystal cell 100-4. Therefore, the S-polarization component of the light emitted from the light source 20 is diffused not only in the x-axis direction but also in the y-axis direction in the second liquid crystal cell 100-2 and the fourth liquid crystal cell 100-4. Accordingly, since the light is diffused in the x-axis direction and the y-axis direction in each of the first liquid crystal cell 100-1 to the fourth liquid crystal cell 100-4, the light passing through the optical element 10 has a circular shape spreading in the x-axis direction and the y-axis direction.

### [6-4. Elliptical Shape]

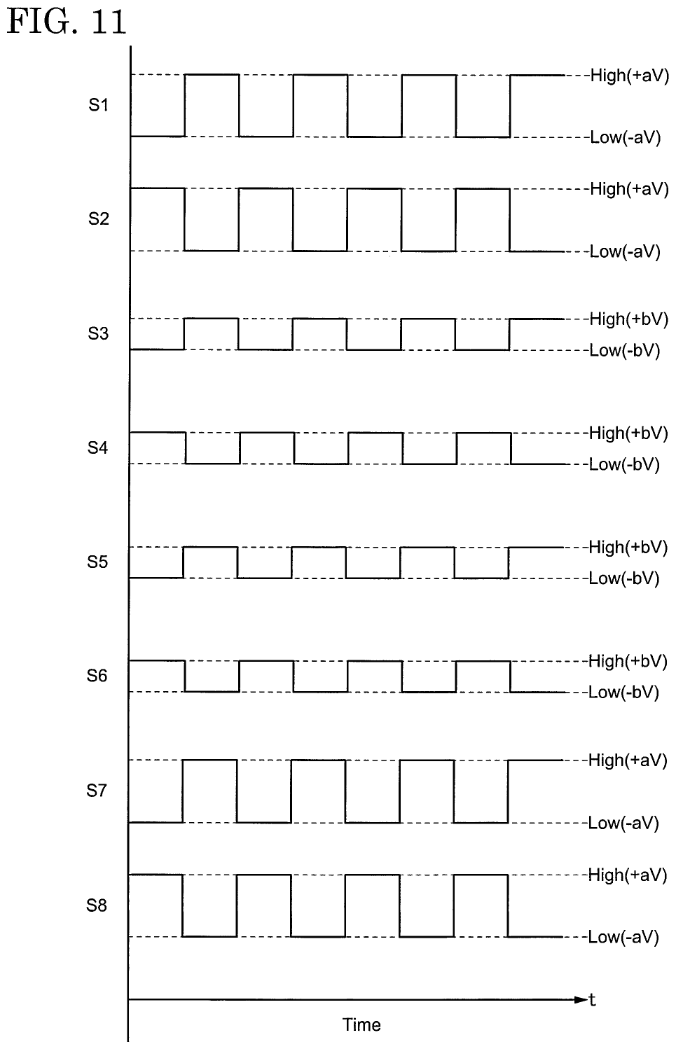

FIG. 11 is a timing chart showing signals input to the optical element 10 to control the light distribution having an elliptical shape in the present embodiment.

Although the timing chart shown in FIG. 11 is almost the same as the timing chart shown in FIG. 10, the amplitudes of the voltages of the first signal S1 to the eighth signal S8 are different. As shown in FIG. 11, the amplitude a of the first signal S1, the second signal S2, the seventh signal S7, and the eighth signal S8 is different from the amplitude b of the third signal S3 to the sixth signal S6. The diffusion in the x-axis direction and the y-axis direction correspond to the amplitude a and the amplitude b, respectively. Therefore, when a>b, the light passing through the optical element 10 is diffused more in the x-axis direction than in the y-axis direction, and has an elliptical shape with the major axis in the x-axis direction. On the other hand, when a<b, the light passing through the optical element 10 is diffused more in the y-axis direction than in the x-axis direction, and has an elliptical shape with the major axis in the y-axis direction.

### [6-5. Cross Shape]

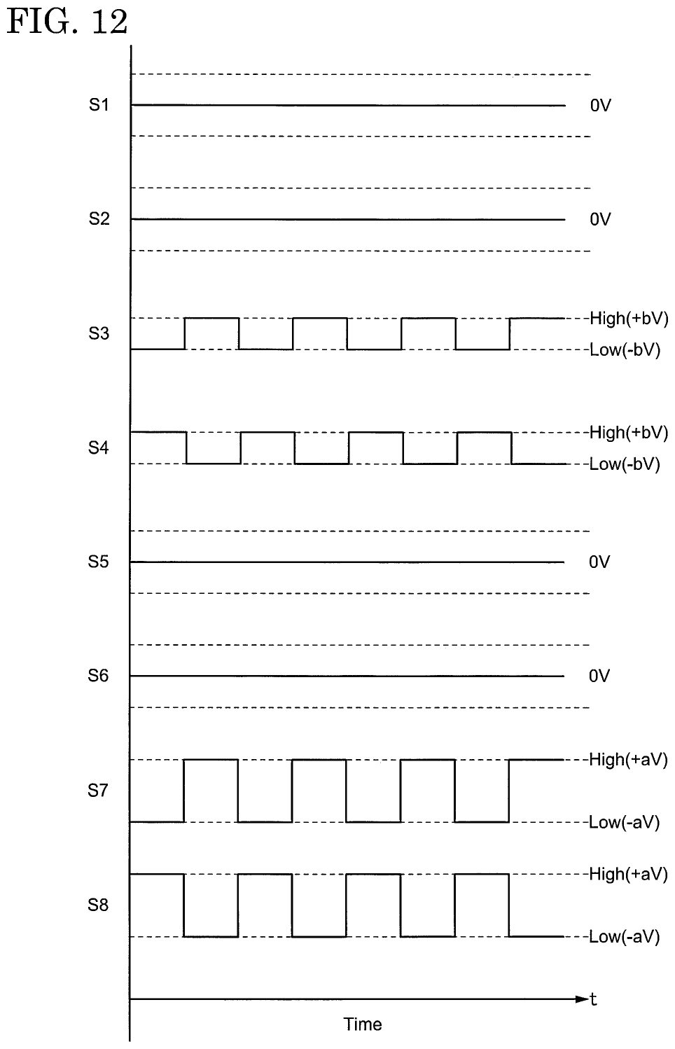

FIG. 12 is a timing chart showing signals input to the optical element 10 to control the light distribution having a cross shape in the present embodiment.

As shown in FIG. 12, each of the third signal S3, the fourth signal S4, the seventh signal S7, and the eighth signal S8 has an AC rectangular wave in which a high voltage and a low voltage are alternately repeated. However, the third signal S3 and the fourth signal S4 have inverted phases, and the seventh signal S7 and the eighth signal S8 have inverted phases. Further, each of the first signal S1, the second signal S2, the fifth signal S5, and the sixth signal S6 is 0V. In this case, the third signal S3 and the fourth signal S4 generate a lateral electric field in the y-axis direction between the third transparent electrode 120-3 and the fourth transparent electrode 120-4 of each of the first liquid crystal cell 100-1 and the third liquid crystal cell 100-3. Therefore, the P-polarization component of the light emitted from the light source 20 is diffused only in the y-axis direction in the first liquid crystal cell 100-1 and the third liquid crystal cell 100-3. Further, the seventh signal S7 and the eighth signal S8 generate a lateral electric field in the x-axis direction between the third transparent electrode 120-3 and the fourth transparent electrode 120-4 of each of the second liquid crystal cell 100-2 and the fourth liquid crystal cell 100-4. Therefore, the S-polarization component of the light emitted from the light source 20 is diffused only in the x-axis direction in the second liquid crystal cell 100-2 and the fourth liquid crystal cell 100-4. Accordingly, since each of the P-polarization component and the S-polarization component is diffused only in one direction of the x-axis direction and the y-axis direction, the light passing through the optical element 10 has a cross shape selectively spreading in the x-axis direction and the y-axis direction. The diffusion width in the x-axis direction (light distribution angle in the x-axis direction) and the diffusion width in the y-axis direction (light distribution angle in the y-axis direction) can be controlled by adjusting the amplitude a and the amplitude b, respectively.

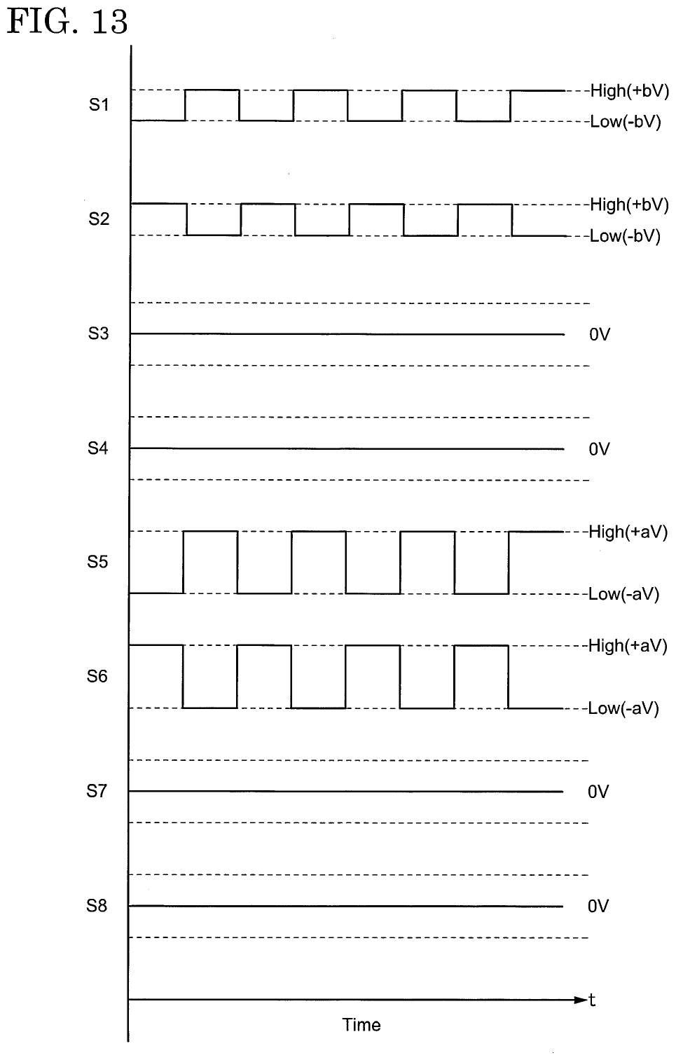

In addition, a timing chart for controlling the light distribution having a cross shape is not limited to the timing chart shown in FIG. 12. In the following description, a modification of the timing chart for controlling the light distribution having a cross shape is described with reference to FIG. 13.

FIG. 13 is another timing chart showing signals input to the optical element 10 for controlling the light distribution having a cross shape in the present embodiment.

As shown in FIG. 13, each of the first signal S1, the second signal S2, the fifth signal S5, and the sixth signal S6 has an AC rectangular wave in which a high voltage and a low voltage are alternately repeated. However, the first signal S1 and the second signal S2 have inverted phases, and the fifth signal S5 and the sixth signal S6 have inverted phases. Further, each of the third signal S3, the fourth signal S4, the seventh signal S7, and the eighth signal S8 is 0V. In this case, the first signal S1 and the second signal S2 generate a lateral electric field in the x-axis direction between the first transparent electrode 120-1 and the second transparent electrode 120-2 of each of the first liquid crystal cell 100-1 and the third liquid crystal cell 100-3. Therefore, the P-polarization component of the light emitted from the light source 20 is diffused only in the x-axis direction in the first liquid crystal cell 100-1 and the third liquid crystal cell 100-3. Further, the fifth signal S5 and the sixth signal S6 generate a lateral electric field in the y-axis direction between the first transparent electrode 120-1 and the second transparent electrode 120-2 of each of the second liquid crystal cell 100-2 and the fourth liquid crystal cell 100-4. Therefore, the S-polarization component of the light emitted from the light source 20 is diffused only in the y-axis direction in the second liquid crystal cell 100-2 and the fourth liquid crystal cell 100-4. Accordingly, since each of the P-polarization component and the S-polarization component is diffused only in one direction of the x-axis direction and the y-axis direction, the light passing through the optical element 10 has a cross shape selectively spreading in the x-axis direction and the y-axis direction. The diffusion width in the x-axis direction (light distribution angle in the x-axis direction) and the diffusion width in the y-axis direction (light distribution angle in the y-axis direction) can be controlled by adjusting the amplitude b and the amplitude a, respectively.

As described above, in the present embodiment, a voltage can be simultaneously applied to the multiple transparent electrodes 120 included in the multiple liquid crystal cells 100 via the inter-cell conductive electrode 400 provided on the side surface of the optical element 10 and the light distribution can be controlled. Therefore, the number of signals input to the optical element 10 can be reduced, and the control of the light distribution of the optical element 10 is simplified. Further, since the number of terminals 210 electrically connected to the transparent electrodes 120 is reduced, the wiring connection in the mounting process (for example, the connection of a FPC or wire bonding to the terminals 210 or the inter-cell conductive electrodes 400) is simplified, and the manufacturing yield of the optical element 10 is improved. Further, the lighting device 1 including the optical element 10 also has excellent light distribution control and improves the manufacturing yield.

### Second Embodiment

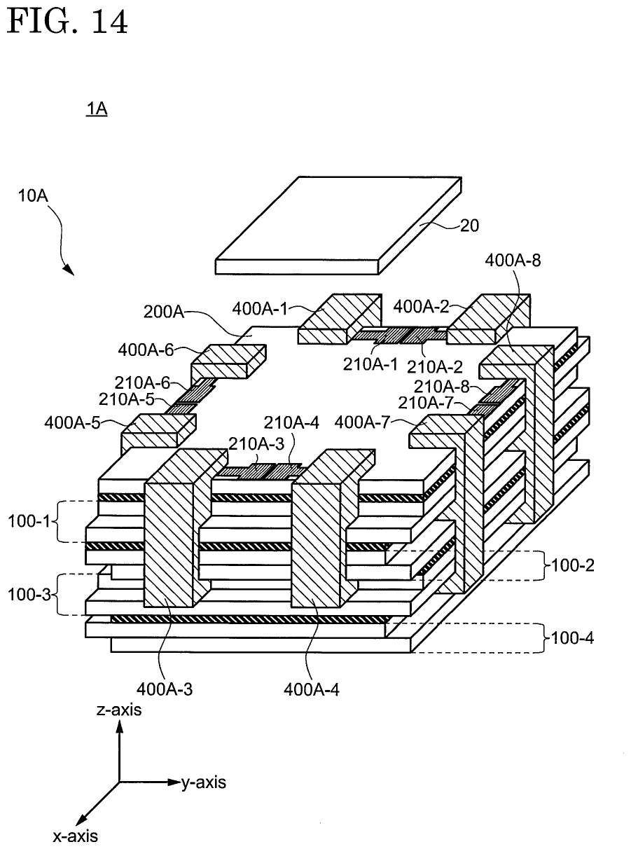

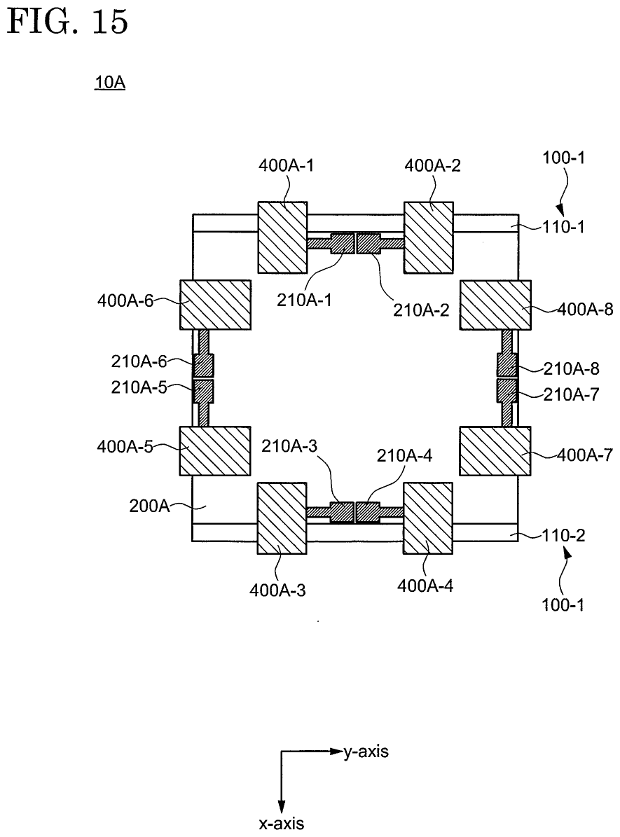

In the present embodiment, a lighting device 1A and an optical element 10A included in the lighting device 1A are described with reference to FIGS. 14 and 15. In addition, when configurations of the lighting device 1A and the optical element 10A are similar to the configurations of the lighting device 1 and the optical element 10 described in the First Embodiment, the description of the configurations of the lighting device 1A and the optical element 10A may be omitted.

FIG. 14 is a schematic perspective view showing a configuration of the lighting device 1A in the present embodiment. FIG. 15 is a schematic plan view showing the configuration of the optical element 10A in the present embodiment. Specifically, FIG. 15 shows a top view of the optical element 10A.

As shown in FIG. 14, the lighting device 1A includes the optical element 10A and the light source 20. The optical element 10A includes the first liquid crystal cell 100-1, the second liquid crystal cell 100-2, the third liquid crystal cell 100-3, the fourth liquid crystal cell 100-4, and a terminal connection substrate 200A. In the optical element 10A, the terminal connection substrate 200A, the first liquid crystal cell 100-1, the second liquid crystal cell 100-2, the third liquid crystal cell 100-3, and the fourth liquid crystal cell 100-4 are stacked in the z-axis direction in this order from the side closer to the light source 20. The configurations and the arrangement directions of the four liquid crystal cells 100 included in the optical element 10A are the same as the configurations and arrangement directions of the four liquid crystal cells 100 described in the First Embodiment.

A third inter-cell conductive electrode 400A-3 and a fourth inter-cell conductive electrode 400A-4 are provided on a first side surface of the optical element 10A. A fifth inter-cell conductive electrode 400A-5 and a sixth inter-cell conductive electrode 400A-6 are provided on a second side surface of the optical element 10A. A seventh inter-cell conductive electrode 400A-7 and an eighth inter-cell conductive electrode 400A-8 are provided on a third side surface of the optical element 10A. A first inter-cell conductive electrode 400A-1 and a second inter-cell conductive electrode 400A-2 are provided on a fourth side surface of the optical element 10A.

As shown in FIG. 15, a first terminal 210A-1 to an eighth terminal 210A-8 are provided on the terminal connection substrate 200A. The first terminal 210A-1 to the eighth terminal 210A-8 are electrically connected to the first inter-cell conductive electrode 400A-1 to the eighth inter-cell conductive electrode 400A-8, respectively. That is, the terminals 210A electrically connected to the inter-cell conductive electrodes 400A are collected on one terminal connection substrate 200A in the optical element 10A. The terminal connection substrate 200A may be disposed adjacent to the fourth liquid crystal cell 100-4. The optical element 10A has a configuration in which one terminal connection substrate 200A is disposed on only one of the top surface or the bottom surface of the optical element 10A.

As described above, in the present embodiment, a voltage can be simultaneously applied to the multiple transparent electrodes 120 included in the multiple liquid crystal cells 100 via the inter-cell conductive electrode 400A provided on the side surface of the optical element 10A, and the light distribution can be controlled. The inter-cell conductive electrode 400A is electrically connected to the terminal 210A on one terminal connection substrate 200A disposed on the top surface or the bottom surface of the optical element 10A. Therefore, the number of terminal connection substrates 200A is reduced, the wiring connection in the mounting process is further simplified, and the manufacturing yield of the optical element 10A is improved. Further, the lighting device 1A including the optical element 10A also has excellent light distribution control and improves the manufacturing yield.

### Third Embodiment

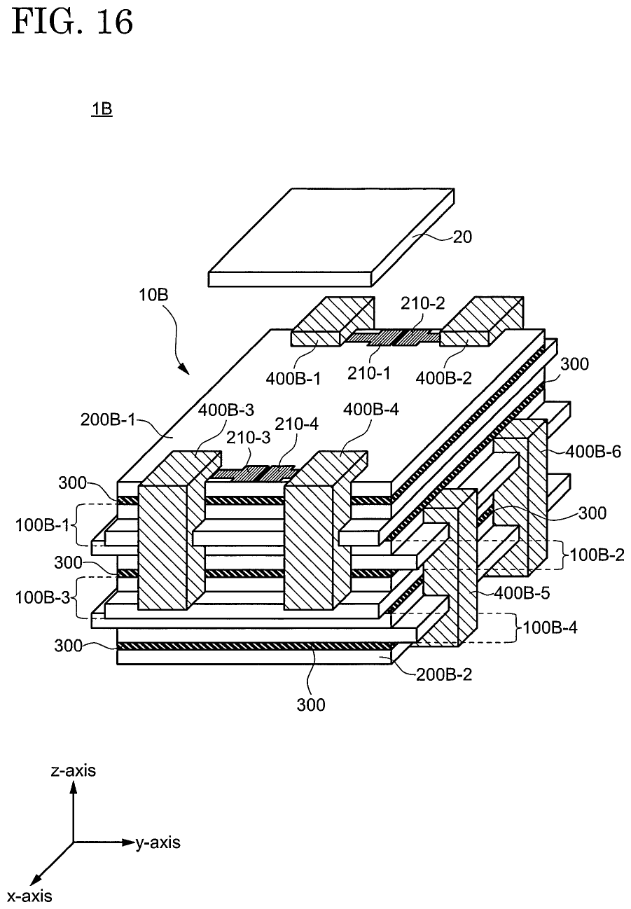

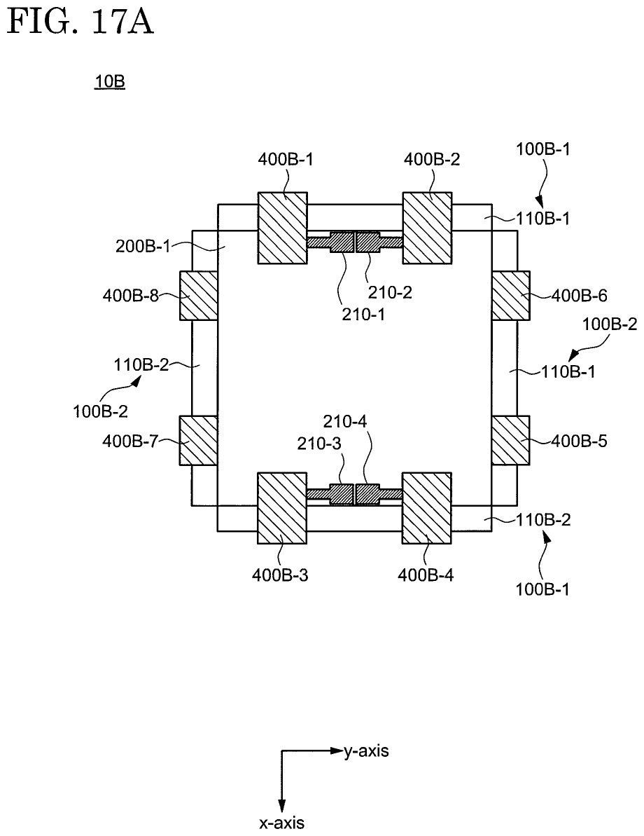

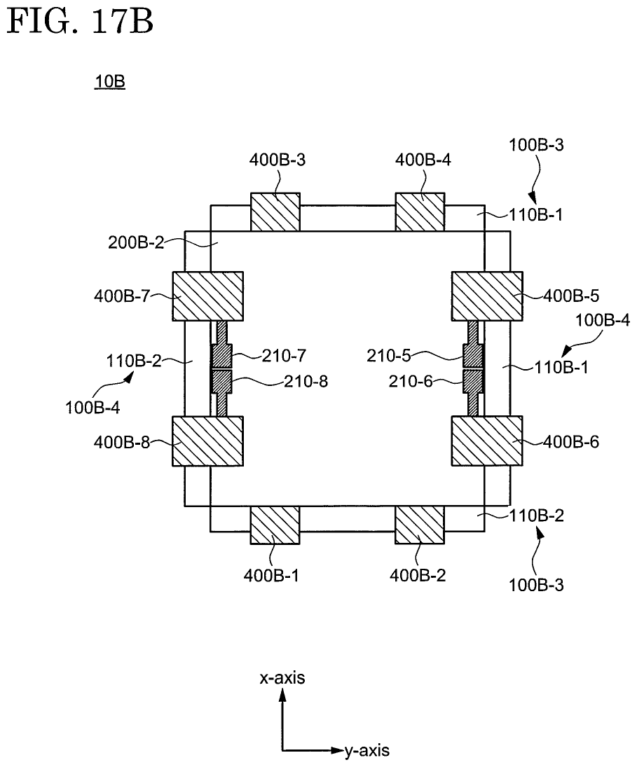

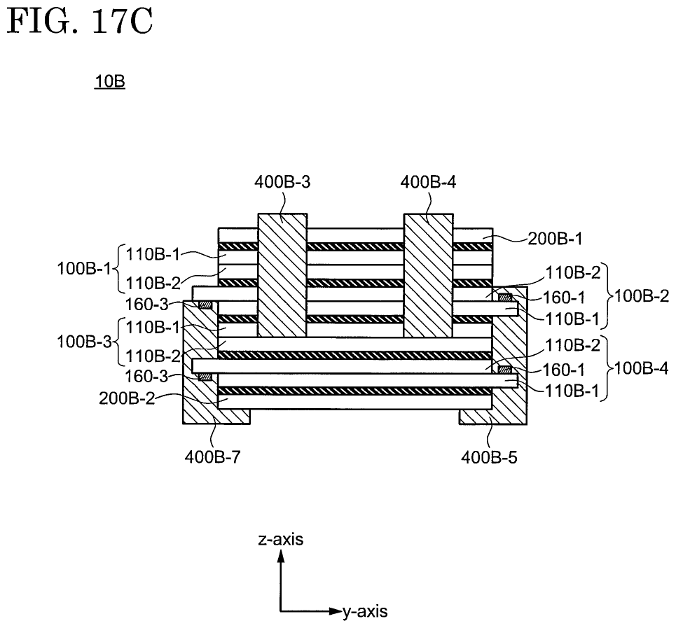

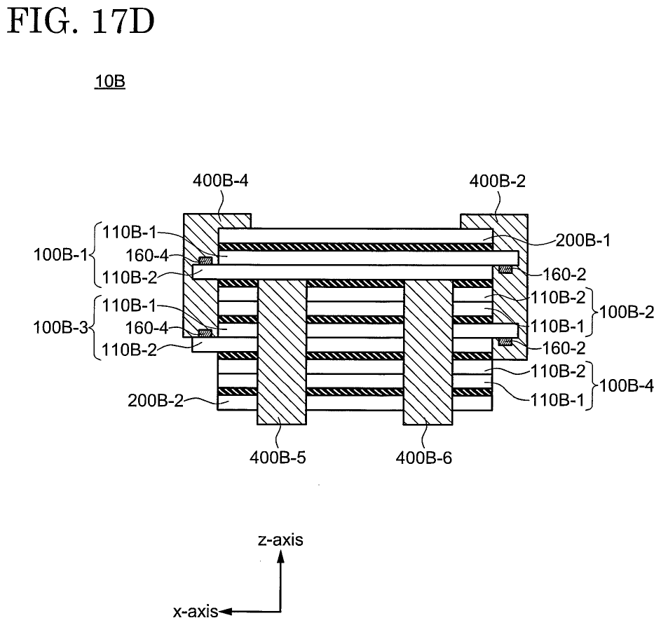

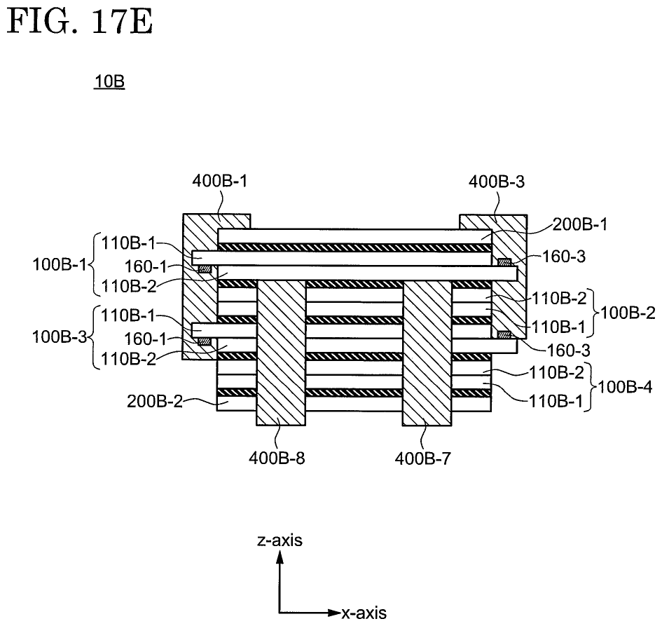

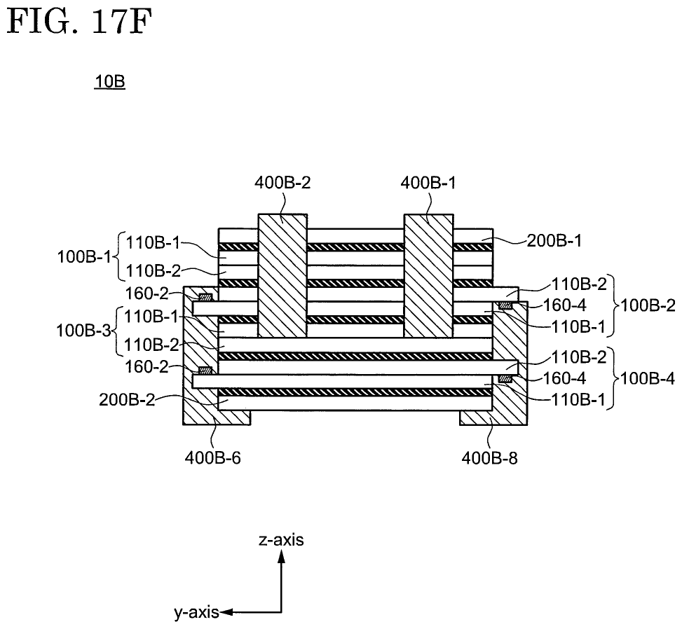

In the present embodiment, a lighting device 1B and an optical element 10B included in the lighting device 1B are described with reference to FIGS. 16 to 17F. In addition, when configurations of the lighting device 1B and the optical element 10B are similar to the configuration of the lighting device 1 and the optical element 10 described in the First Embodiment, the description of the configurations of the lighting device 1B and the optical element 10B may be omitted.

FIG. 16 is a schematic perspective view showing a configuration of the lighting device 1B in the present embodiment. FIGS. 17A to 17F are schematic plan views showing a configuration of the optical element 10B in the present embodiment. Specifically, FIGS. 17A to 17F respectively show a top view, a bottom view, a front view, a right side view, a left side view, and a back view of the optical element 10B.

As shown in FIG. 16, the lighting device 1B includes the optical element 10B and the light source 20. The optical element 10B includes a first liquid crystal cell 100B-1, a second liquid crystal cell 100B-2, a third liquid crystal cell 100B-3, a fourth liquid crystal cell 100B-4, a first terminal connection substrate 200B-1, and a second terminal connection substrate 200B-2. In the optical element 10B, the first terminal connection substrate 200B-1, the first liquid crystal cell 100B-1, the second liquid crystal cell 100B-2, the third liquid crystal cell 100B-3, the fourth liquid crystal cell 100B-4, and the second terminal connection substrate 200B-2 are stacked in the z-axis direction in this order from the side closer to the light source 20. The planar shape of the liquid crystal cell 100B is different from the planar shape of the liquid crystal cell 100 described in the First Embodiment. However, the configuration of the liquid crystal cell 100B other than the planar shape is the same as the configuration of the liquid crystal cell 100. Further, the arrangement directions of the four liquid crystal cells 100B included in the optical element 10B is the same as the arrangement directions of the four liquid crystal cells 100 described in the First Embodiment.

As shown in FIGS. 17A and 17B, the planar shape of the liquid crystal cell 100B is a substantially rectangular shape having short and long sides. Therefore, the corners of the first liquid crystal cell 100-1 to the fourth liquid crystal cell 100-1 do not coincide with each other. Further, in the optical element 10B, the connection pad 160 is provided on the short sides of the liquid crystal cell 100B and is exposed on the side surface of the optical element 10B.

Inter-cell conductive electrodes 400B (a first inter-cell conductive electrode 400B-1 to an eighth inter-cell conductive electrode 400B-8) extend in the z-axis direction on the side surfaces of the optical element 10B, and electrically connect the connection pads 160 (a first connection pad 160-1 to a fourth connection pad 160-4) exposed on the side surface of the optical element 10B to the terminals 210 on the terminal connection substrate 200B. The first inter-cell conductive electrode 400B-1 is provided on the fourth side surface (back surface), and electrically connects the first connection pad 160-1 of the first liquid crystal cell 100B-1 and the first connection pad 160-1 of the third liquid crystal cell 100B-3 to the first terminal 210-1 on the first terminal connection substrate 200B-1. The second inter-cell conductive electrode 400B-2 is provided on the fourth side surface (back surface) and electrically connects the second connection pad 160-2 of the first liquid crystal cell 100B-1 and the second connection pad 160-2 of the third liquid crystal cell 100B-3 to the second terminal 210-2 on the first terminal connection substrate 200B-1. The third inter-cell conductive electrode 400B-3 is provided on the first side surface (front surface) and electrically connects the third connection pad 160-3 of the first liquid crystal cell 100B-1 and the third connection pad 160-3 of the third liquid crystal cell 100B-3 to the third terminal 210-3 on the first terminal connection substrate 200B-1. The fourth inter-cell conductive electrode 400B-4 is provided on the first side surface (front surface) and electrically connects the fourth connection pad 160-4 of the first liquid crystal cell 100B-1 and the fourth connection pad 160-4 of the third liquid crystal cell 100B-3 to the fourth terminal 210-4 on the first terminal connection substrate 200B-1. The fifth inter-cell conductive electrode 400B-5 is provided on the second side surface (right side) and electrically connects the first connection pad 160-1 of the second liquid crystal cell 100B-2 and the first connection pad 160-1 of the fourth liquid crystal cell 100B-4 to the fifth terminal 210-5 on the second terminal connection substrate 200B-2. The sixth inter-cell conductive electrode 400B-6 is provided on the second side (right side) and electrically connects the second connection pad 160-2 of the second liquid crystal cell 100B-2 and the second connection pad 160-2 of the fourth liquid crystal cell 100B-4 to the sixth terminal 210-6 on the second terminal connection substrate 200B-2. The seventh inter-cell conductive electrode 400B-7 is provided on the third side (left side) and electrically connects the third connection pad 160-3 of the second liquid crystal cell 100B-2 and the third connection pad 160-3 of the fourth liquid crystal cell 100B-4 to the seventh terminal 210-7 on the second terminal connection substrate 200B-2. The eighth inter-cell conductive electrode 400B-8 is provided on the third side (left side) and electrically connects the fourth connection pad 160-4 of the second liquid crystal cell 1001B-2 and the fourth connection pad 160-4 of the fourth liquid crystal cell 100B-4 to the eighth terminal 210-8 on the second terminal connection substrate 200B-2.

Since the planar shape of the liquid crystal cell 100B is substantially rectangular in the optical element 10B, only the substrate 110 on which the connection pad 160 is provided protrudes from the side surface of the optical element 10B. Thus, it is possible to increase the distance between the two substrates 110 provided with the connection pads 160 which are electrically connected to the inter-cell conductive electrodes 400B. In other words, a large step is formed on the side surface of the optical element 10B. Therefore, since a larger amount of conductive adhesive is injected into the step formed between the two substrates 110, it is possible to prevent disconnection of the inter-cell conductive electrodes 400B.

As described above, in the present embodiment, a voltage is simultaneously applied to the multiple transparent electrodes 120 included in the multiple liquid crystal cells 100B via the inter-cell conductive electrode 400B provided on the side surface of the optical element 10B, and the light distribution can be controlled. Since the conductive adhesive constituting the inter-cell conductive electrode 400B is injected more into the large step formed on the side surface of the optical element 10B, disconnection of the inter-cell conductive electrode 400B is prevented and the manufacturing yield of the optical element 10B is improved. Further, the lighting device 1B including the optical element 10B also has excellent light distribution control and improves the manufacturing yield.

### Fourth Embodiment

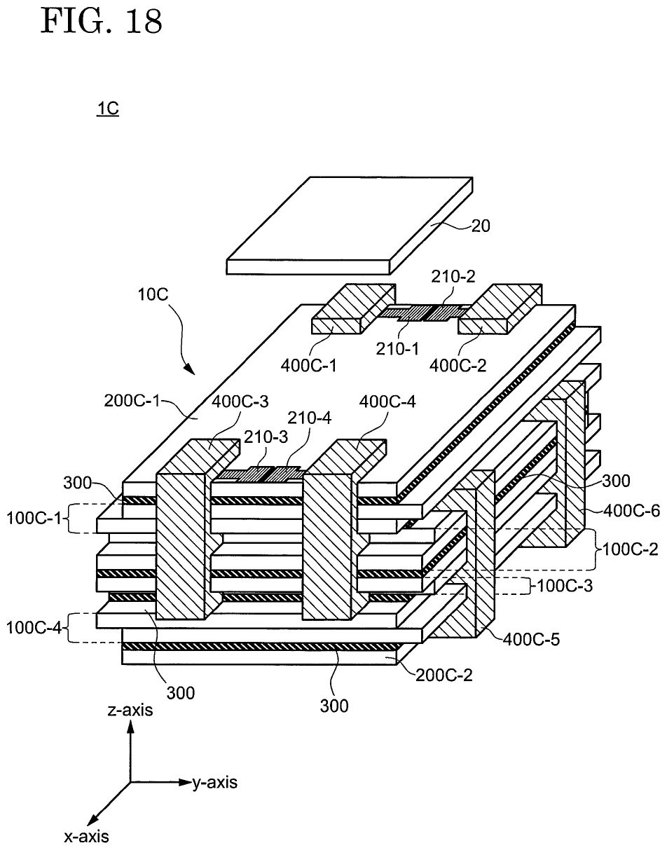

In the present embodiment, the lighting device 1C and the optical element 10C included in the lighting device 1C are described with reference to FIGS. 18 to 20G. In addition, when configurations of the lighting device 1C and the optical element 10C are similar to the configurations of the lighting device 1 and the optical element 10 described in the First Embodiment, the description of the configurations of the lighting device 1C and the optical element 10C may be omitted.

### [1. Configuration of Lighting Device 1C]

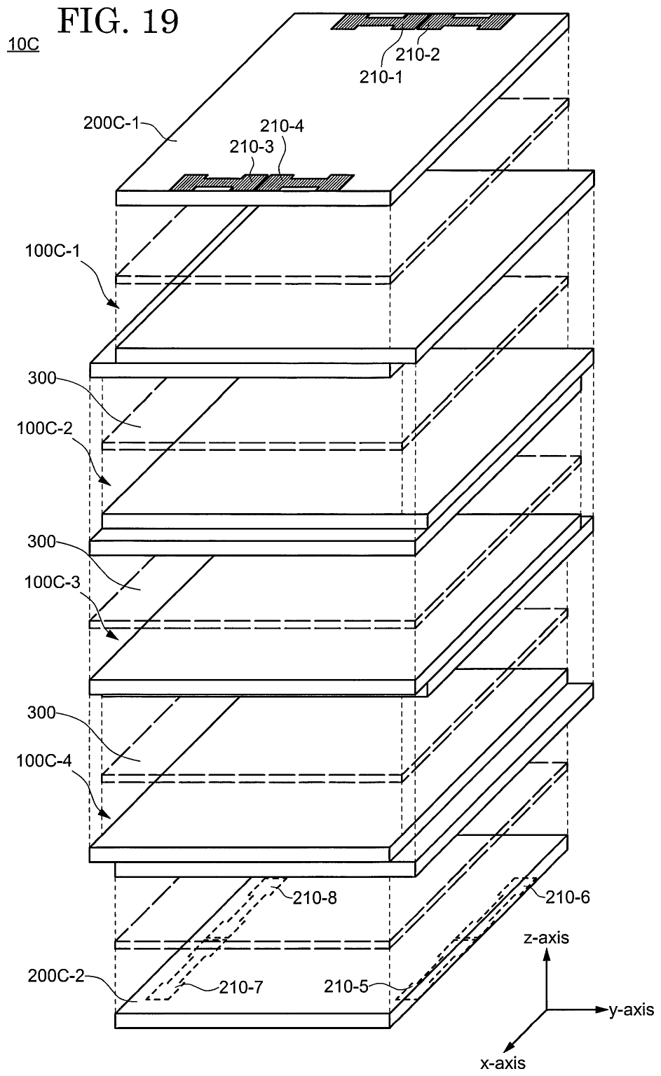

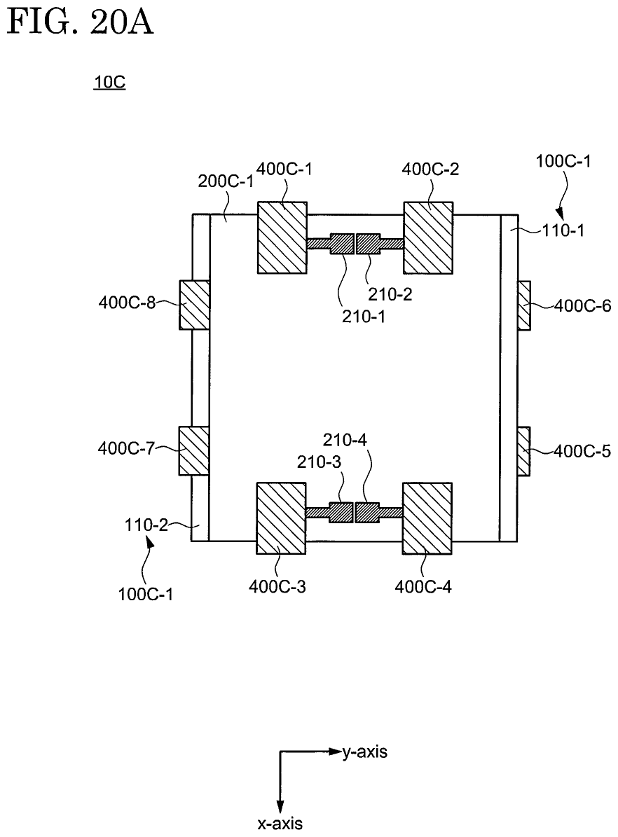

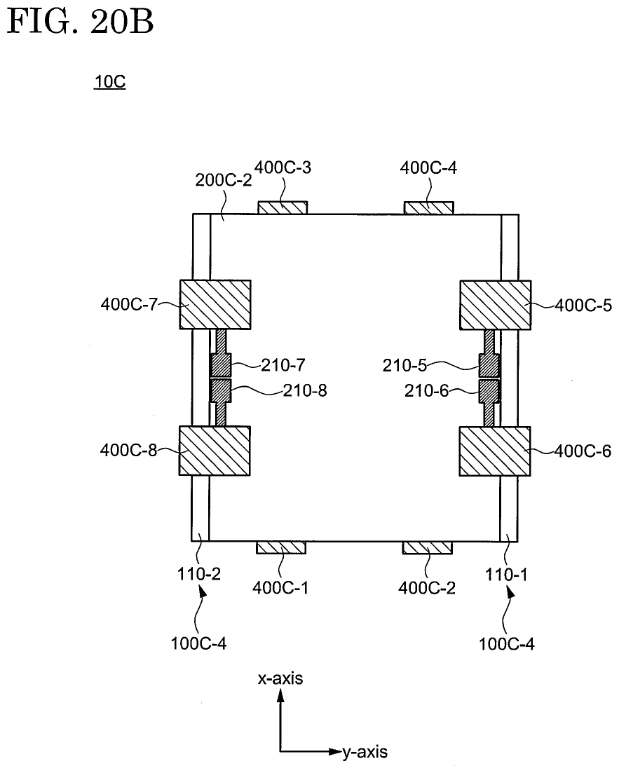

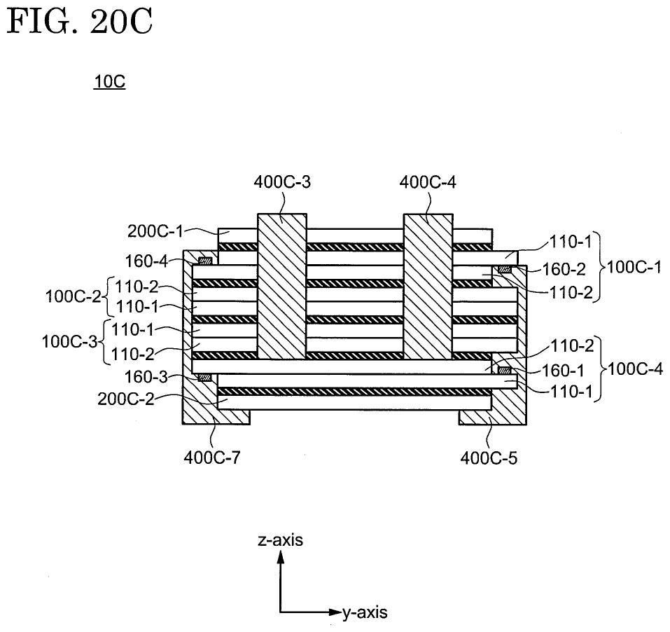

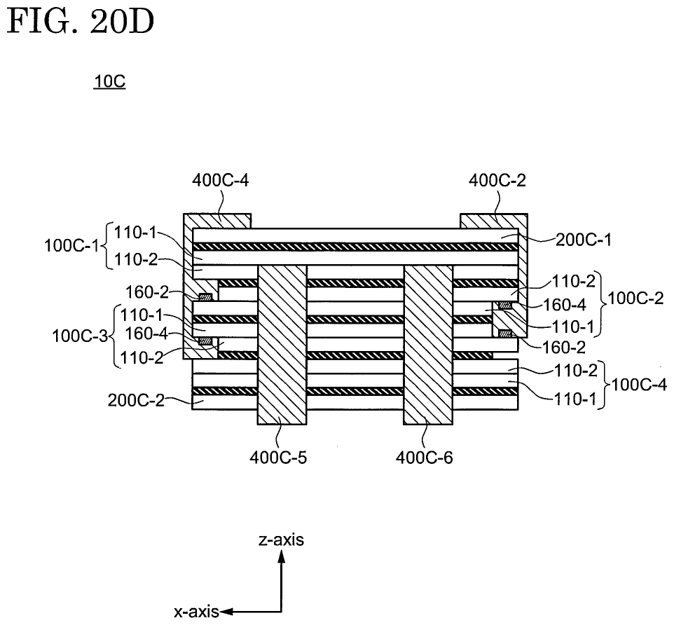

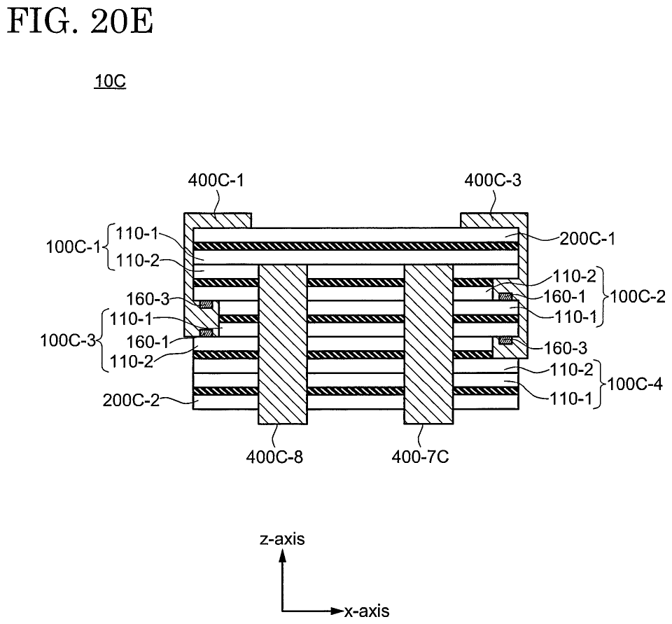

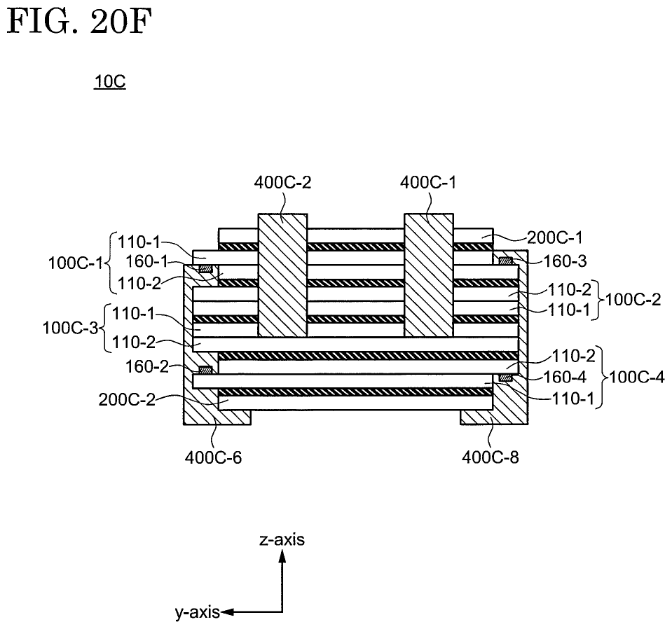

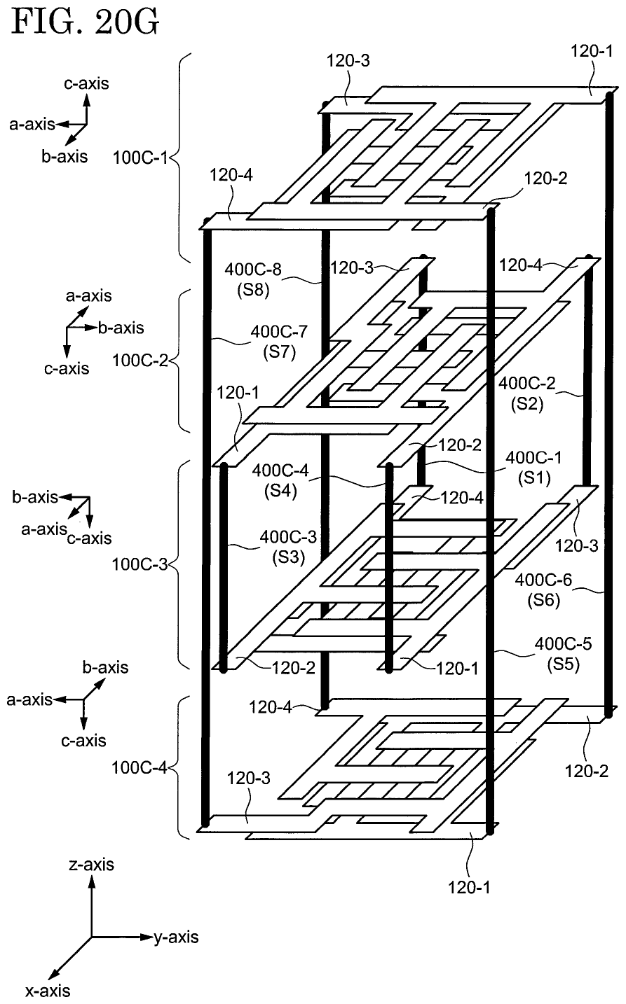

FIG. 18 is a schematic perspective view showing a configuration of the lighting device 1C in the present embodiment. FIG. 19 is a schematic exploded perspective view showing a configuration of the optical element 10C in the present embodiment. FIGS. 20A to 20F are plan views showing a configuration of electrical connections of the optical element 10C in the present embodiment. Specifically, FIGS. 20A to 20F respectively show a top view, a bottom view, a front view, a right side view, and a back view of the optical element 10C. FIG. 20G is a schematic perspective view showing the configuration of the electrical connections of the optical element 10C in the present embodiment. Specifically, FIG. 20G shows the electrical connections of the transparent electrodes 120 of each liquid crystal cell 1000 in the optical element 10C.

As shown in FIG. 18, the lighting device 1C includes the optical element 10C and the light source 20. The optical element 10C includes a first liquid crystal cell 1000-1, a second liquid crystal cell 1000-2, a third liquid crystal cell 1000-3, a fourth liquid crystal cell 1000-4, a first terminal connection substrate 2000-1, and a second terminal connection substrate 2000-2. In the optical element 10C, the first terminal connection substrate 2000-1, the first liquid crystal cell 1000-1, the second liquid crystal cell 1000-2, the third liquid crystal cell 1000-3, the fourth liquid crystal cell 1000-4, and the second terminal connection substrate 2000-2 are stacked in the z-axis direction in this order from the side closest to the light source 20.

The configuration of each of the first liquid crystal cell 1000-1 to the fourth liquid crystal cell 1000-4 is the same as the configuration of the liquid crystal cell 100 described in the First Embodiment. However, the arrangement directions of the first liquid crystal cell 1000-1 to the fourth liquid crystal cell 1000-4 are different from the arrangement directions of the first liquid crystal cell 100-1 to the fourth liquid crystal cell 100-4 described in the First Embodiment. Therefore, the arrangement direction of each of the first liquid crystal cell 1000-1 to the fourth liquid crystal cell 1000-4 is described with reference to FIGS. 20A to 20G. The first liquid crystal cell 1000-1 is arranged so that the +a-axis direction, the +b-axis direction, and the +c-axis direction of the liquid crystal cell 100 correspond to the +y-axis direction, the −x-axis direction, and the +z-axis direction of the optical element 10C, respectively. The second liquid crystal cell 1000-2 is arranged such that the +a-axis direction, the +b-axis direction, and the +c-axis direction of the liquid crystal cell 100 correspond to the −x-axis direction, the +y-axis direction, and the −z-axis direction of the optical element 10C, respectively. The third liquid crystal cell 1000-3 is arranged such that the +a-axis direction, the +b-axis direction, and the +c-axis direction of the liquid crystal cell 100 correspond to the +x-axis direction, the −y-axis direction, and the −z-axis direction of the optical element 10C, respectively. The fourth liquid crystal cell 1000-4 is arranged such that the +a-axis direction, the +b-axis direction, and the +c-axis direction of the liquid crystal cell 100 correspond to the −y-axis direction, the −x-axis direction, and the −z-axis direction of the optical element 10C, respectively.

Therefore, the first connection pad 160-1 and the second connection pad 160-2 of the second liquid crystal cell 1000-2 and the first connection pad 160-1 and the second connection pad 160-2 of the third liquid crystal cell 1000-3 are exposed on the first side surface (front surface) of the optical element 10C. Further, the first connection pad 160-1 and the second connection pad 160-2 of the first liquid crystal cell 1000-1 and the first connection pad 160-1 and the second connection pad 160-2 of the fourth liquid crystal cell 1000-4 are exposed on the second side surface (right side) of the optical element 10C. Furthermore, the third connection pad 160-3 and the fourth connection pad 160-4 of the first liquid crystal cell 1000-1 and the third connection pad 160-3 and the fourth connection pad 160-4 of the fourth liquid crystal cell 1000-4 are exposed on the third side surface (left side) of the optical element 10C. Moreover, the third connection pad 160-3 and the fourth connection pad 160-4 of the second liquid crystal cell 1000-2 and the third connection pad 160-3 and the fourth connection pad 160-4 of the third liquid crystal cell 1000-3 are exposed on the fourth side surface (back surface) of the optical element 10C.

An inter-cell conductive electrode 4000 extends in the z-axis direction on the side surface of the optical element 10C, and electrically connects the connection pad 160 exposed on the side surface of the optical element 10C to the terminal 210 on the terminal connection substrate 2000. The first inter-cell conductive electrode 4000-1 is provided on the fourth side surface (back surface), and electrically connects the third connection pad 160-3 of the second liquid crystal cell 1000-2 and the fourth connection pad 160-4 of the third liquid crystal cell 1000-3 to the first terminal 210-1 on the first terminal connection substrate 2000-1. The second inter-cell conductive electrode 4000-2 is provided on the fourth side surface (back surface) and electrically connects the fourth connection pad 160-4 of the second liquid crystal cell 1000-2 and the third connection pad 160-3 of the third liquid crystal cell 1000-3 to the second terminal 210-2 on the first terminal connection substrate 2000-1. The third inter-cell conductive electrode 4000-3 is provided on the first side surface (front surface) and electrically connects the first connection pad 160-1 of the second liquid crystal cell 1000-2 and the second connection pad 160-2 of the third liquid crystal cell 1000-3 to the third terminal 210-3 on the first terminal connection substrate 2000-1. The fourth inter-cell conductive electrode 4000-4 is provided on the first side surface (front surface) and electrically connects the second connection pad 160-2 of the second liquid crystal cell 1000-2 and the first connection pad 160-1 of the third liquid crystal cell 1000-3 to the fourth terminal 210-4 on the first terminal connection substrate 2000-1. The fifth inter-cell conductive electrode 4000-5 is provided on the second side surface (right side surface) and electrically connects the second connection pad 160-2 of the first liquid crystal cell 1000-1 and the first connection pad 160-1 of the fourth liquid crystal cell 1000-4 to the fifth terminal 210-5 on the second terminal connection substrate 2000-2. The sixth inter-cell conductive electrode 4000-6 is provided on the second side (right side) and electrically connects the first connection pad 160-1 of the first liquid crystal cell 1000-1 and the second connection pad 160-2 of the fourth liquid crystal cell 1000-4 to the sixth terminal 210-6 on the second terminal connection substrate 2000-2. The seventh inter-cell conductive electrode 4000-7 is provided on the third side (left side) and electrically connects the fourth connection pad 160-4 of the first liquid crystal cell 1000-1 and the third connection pad 160-3 of the fourth liquid crystal cell 1000-4 to the seventh terminal 210-7 on the second terminal connection substrate 2000-2. The eighth inter-cell conductive electrode 4000-8 is provided on the third side (left side) and electrically connects the third connection pad 160-3 of the first liquid crystal cell 1000-1 and the fourth connection pad 160-4 of the fourth liquid crystal cell 1000-4 to the eighth terminal 210-8 on the second terminal connection substrate 2000-2.

In the optical element 10C including the first liquid crystal cell 1000-1 to the fourth liquid crystal cell 1000-4 having the above-described alignment directions, the first liquid crystal cell 1000-1 and the fourth liquid crystal cell 1000-4 can control the diffusion of the S-polarization component of the light, and the second liquid crystal cell 1000-2 and the third liquid crystal cell 1000-3 can control the diffusion of the P-polarization component of the light.

Therefore, also in the optical element 10C, it is possible to simultaneously apply a voltage corresponding to a signal to two transparent electrodes 120 included in two different liquid crystal cells 1000 by simply inputting the signal to one terminal 210.

Specifically, as shown in FIG. 20G, the first signal S1 input to the first terminal 210-1 is input to the third transparent electrode 120-3 of the second liquid crystal cell 1000-2 and the fourth transparent electrode 120-4 of the third liquid crystal cell 1000-3 via the first inter-cell conductive electrode 4000-1. The second signal S2 input to the second terminal 210-2 is input to the fourth transparent electrode 120-4 of the second liquid crystal cell 1000-2 and the third transparent electrode 120-3 of the third liquid crystal cell 1000-3 via the second inter-cell conductive electrode 4000-2. The third signal S3 input to the third terminal 210-3 is input to the first transparent electrode 120-1 of the second liquid crystal cell 1000-2 and the second transparent electrode 120-2 of the third liquid crystal cell 1000-3 via the third inter-cell conductive electrode 4000-3. The fourth signal S4 input to the fourth terminal 210-4 is input to the second transparent electrode 120-2 of the second liquid crystal cell 1000-2 and the first transparent electrode 120-1 of the third liquid crystal cell 1000-3 via the fourth inter-cell conductive electrode 4000-4. The fifth signal S5 input to the fifth terminal 210-5 is input to the second transparent electrode 120-2 of the first liquid crystal cell 1000-1 and the first transparent electrode 120-1 of the fourth liquid crystal cell 1000-4 via the fifth inter-cell conductive electrode 4000-5. The sixth signal S6 input to the sixth terminal 210-6 is input to the first transparent electrode 120-1 of the first liquid crystal cell 1000-1 and the second transparent electrode 120-2 of the fourth liquid crystal cell 1000-4 via the sixth inter-cell conductive electrode 4000-6. The seventh signal S7 input to the seventh terminal 210-7 is input to the fourth transparent electrode 120-4 of the first liquid crystal cell 1000-1 and the third transparent electrode 120-3 of the fourth liquid crystal cell 1000-4 via the seventh inter-cell conductive electrode 4000-7. The eighth signal S8 input to the eighth terminal 210-8 is input to the third transparent electrode 120-3 of the first liquid crystal cell 1000-1 and the fourth transparent electrode 120-4 of the fourth liquid crystal cell 1000-4 via the eighth inter-cell conductive electrode 4000-8.

### [2. Light Distribution Control of Optical Element 10C]

Electrical connections in the optical element 10C can also control the light distribution having different shapes. The control of the light distribution in the optical element 10C is described below.

### [2-1. Linear Shape Spreading in X-axis Direction]

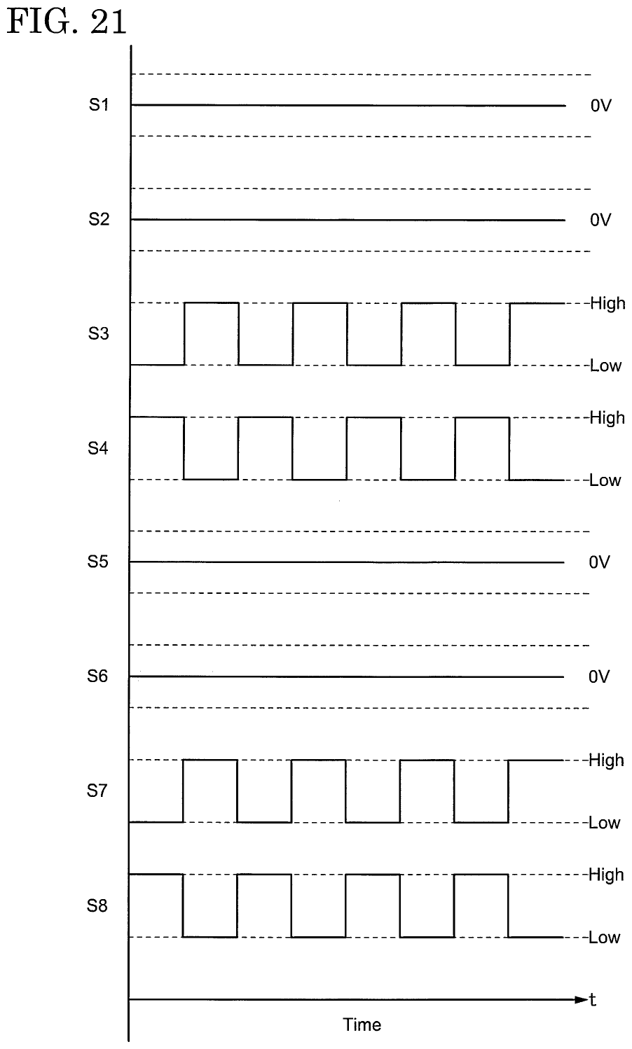

FIG. 21 is a timing chart showing signals input to the optical element 10C for controlling the light distribution having a linear shape in the x-axis direction in the present embodiment.

As shown in FIG. 21, each of the third signal S3, the fourth signal S4, the seventh signal S7, and the eighth signal S8 has an AC rectangular wave in which a high voltage and a low voltage are alternately repeated. However, the third signal S3 and the fourth signal S4 have inverted phases, and the seventh signal S7 and the eighth signal S8 have inverted phases. Further, each of the first signal S1, the second signal S2, the fifth signal S5, and the sixth signal S6 is 0V. In this case, the third signal S3 and the fourth signal S4 generate a lateral electric field in the x-axis direction between the first transparent electrode 120-1 and the second transparent electrode 120-2 of each of the second liquid crystal cell 1000-2 and the third liquid crystal cell 1000-3. Therefore, the P-polarization component of the light emitted from the light source 20 is diffused only in the x-axis direction in the second liquid crystal cell 1000-2 and the third liquid crystal cell 1000-3. Further, the seventh signal S7 and the eighth signal S8 generate a lateral electric field in the x-axis direction between the third transparent electrode 120-3 and the fourth transparent electrode 120-4 of each of the first liquid crystal cell 1000-1 and the fourth liquid crystal cell 1000-4. Therefore, the S-polarization component of the light emitted from the light source 20 is diffused only in the x-axis direction in the first liquid crystal cell 1000-1 and the fourth liquid crystal cell 1000-4. Accordingly, since the light is diffused in the x-axis direction in each of the first liquid crystal cell 1000-1 to the fourth liquid crystal cell 1000-4, the light passing through the optical element 10C has a linear shape spreading in the x-axis direction. The diffusion width in the x-axis direction (light distribution angle in the x-axis direction) can be controlled by adjusting the potential difference between the high voltage and the low voltage. For example, as the potential difference increases, the diffusion width in the x-axis direction increases.

### [2-2. Linear Shape Spreading in Y-axis Direction]

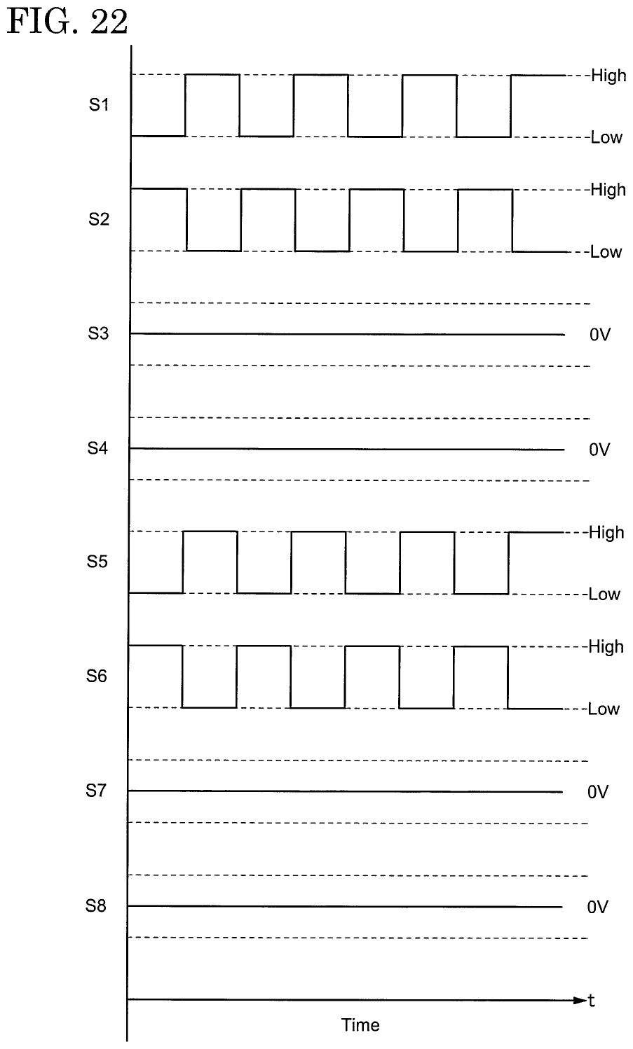

FIG. 22 is a timing chart showing signals input to the optical element 10C for controlling the light distribution having a linear shape in the y-axis direction in the present embodiment.

As shown in FIG. 22, each of the first signal S1, the second signal S2, the fifth signal S5, and the sixth signal S6 has an AC rectangular wave in which a high voltage and a low voltage are alternately repeated. However, the first signal S1 and the second signal S2 have inverted phases, and the fifth signal S5 and the sixth signal S6 have inverted phases. Further, each of the third signal S3, the fourth signal S4, the seventh signal S7, and the eighth signal S8 is 0V. In this case, the first signal S1 and the second signal S2 generate a lateral electric field in the y-axis direction between the third transparent electrode 120C-3 and the fourth transparent electrode 120C-4 of each of the second liquid crystal cell 1000-2 and the third liquid crystal cell 1000-3. Therefore, the P-polarization component of the light emitted from the light source 20 is diffused only in the y-axis direction in the second liquid crystal cell 1000-2 and the third liquid crystal cell 1000-3. Further, the fifth signal S5 and the sixth signal S6 generate a lateral electric field in the y-axis direction between the first transparent electrode 120-1 and the second transparent electrode 120-2 of each of the first liquid crystal cell 1000-1 and the fourth liquid crystal cell 1000-4. Therefore, the S-polarization component of the light emitted from the light source 20 is diffused only in the y-axis direction in the first liquid crystal cell 1000-1 and the fourth liquid crystal cell 1000-4. Accordingly, since the light is diffused in the y-axis direction in each of the first liquid crystal cell 1000-1 to the fourth liquid crystal cell 1000-4, the light passing through the optical element 10C has a linear shape spreading in the y-axis direction. The diffusion width in the y-axis direction (light distribution angle in the y-axis direction) can be controlled by adjusting the potential difference between the high voltage and the low voltage. For example, as the potential difference increases, the diffusion width in the y-axis direction increases.

### [2-3. Circular Shape]

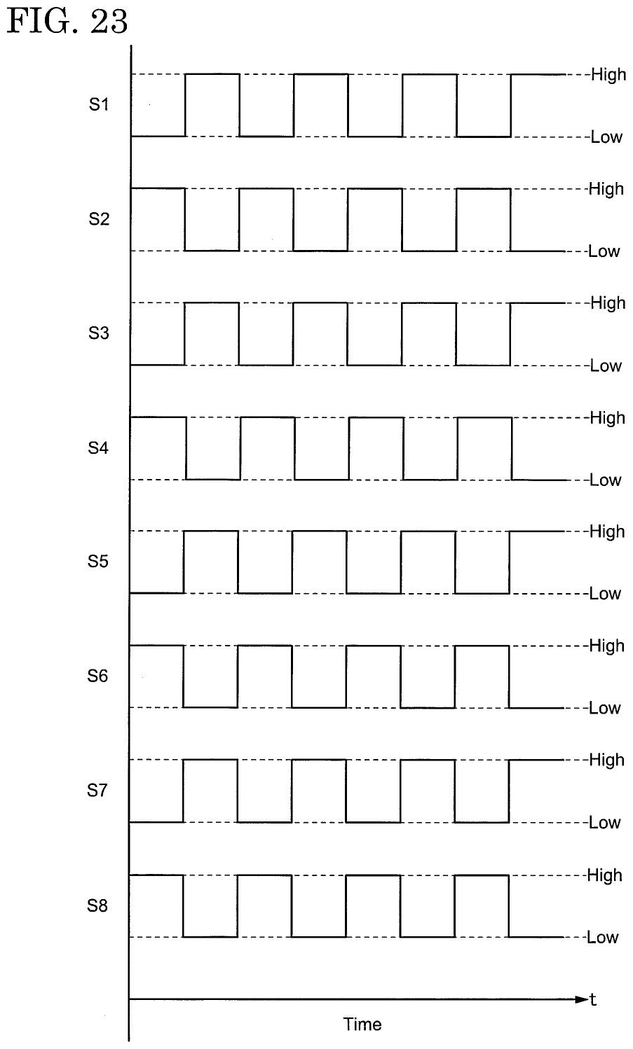

FIG. 23 is a timing chart showing signals input to the optical element 10C for controlling the light distribution having a circular shape in the present embodiment.

As shown in FIG. 23, each of the first signal S1 to the eighth signal S8 has an AC rectangular wave in which a high voltage and a low voltage are alternately repeated. However, the first signal S1 and the second signal S2 have inverted phases, the third signal S3 and the fourth signal S4 have inverted phases, the fifth signal S5 and the sixth signal S6 have inverted phases, and the seventh signal S7 and the eighth signal S8 have inverted phases. In this case, the first signal S1 and the second signal S2 generate a lateral electric field in the y-axis direction between the third transparent electrode 120-3 and the fourth transparent electrode 120-4 of each of the second liquid crystal cell 1000-2 and the third liquid crystal cell 1000-3. Further, the third signal S3 and the fourth signal S4 generate a lateral electric field in the x-axis direction between the first transparent electrode 120-1 and the second transparent electrode 120-2 of each of the second liquid crystal cell 1000-2 and the third liquid crystal cell 1000-3. Therefore, the P-polarization component of the light emitted from the light source 20 is diffused not only in the x-axis direction but also in the y-axis direction in the second liquid crystal cell 1000-2 and the third liquid crystal cell 1000-3. Further, the fifth signal S5 and the sixth signal S6 generate a lateral electric field in the y-axis direction between the first transparent electrode 120-1 and the second transparent electrode 120-2 of each of the first liquid crystal cell 1000-1 and the fourth liquid crystal cell 1000-4. Furthermore, the seventh signal S7 and the eighth signal S8 generate a lateral electric field in the x-axis direction between the third transparent electrode 120-3 and the fourth transparent electrode 120-4 of each of the first liquid crystal cell 1000-1 and the fourth liquid crystal cell 1000-4. Therefore, the S-polarization component of the light emitted from the light source 20 is diffused not only in the x-axis direction but also in the y-axis direction in the first liquid crystal cell 1000-1 and the fourth liquid crystal cell 1000-4. Accordingly, since the light is diffused in the x-axis direction and the y-axis direction in each of the first liquid crystal cell 1000-1 to the fourth liquid crystal cell 1000-4, the light passing through the optical element 10 has a circular shape spreading in the x-axis direction and the y-axis direction.

### [2-4. Elliptical Shape]

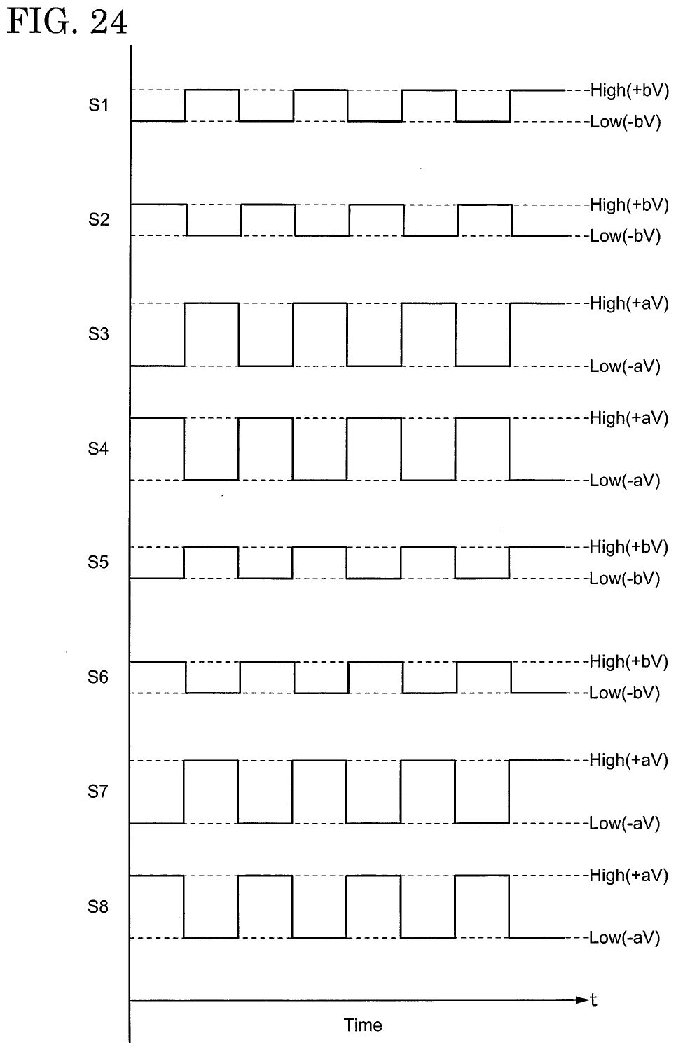

FIG. 24 is a timing chart showing signals input to the optical element 10C for controlling the light distribution having an elliptical shape in the present embodiment.

Although the timing chart shown in FIG. 24 is almost the same as the timing chart shown in FIG. 23, the amplitudes of the voltages of the first signal S1 to the eighth signal S8 are different. As shown in FIG. 24, the amplitude a of the third signal S3, the fourth signal S4, the seventh signal S7, and the eighth signal S8 is different from the amplitude b of the first signal S1, the second signal S2, the fifth signal S5, and the sixth signal S6. The diffusion in the x-axis direction and the y-axis direction correspond to the amplitude a and the amplitude b, respectively. Therefore, when a>b, the light passing through the optical element 10 is diffused more in the x-axis direction than in the y-axis direction, and has an elliptical shape with the major axis in the x-axis direction. On the other hand, when a<b, the light passing through the optical element 10 is diffused more in the y-axis direction than in the x-axis direction, and has an elliptical shape with the major axis in the y-axis direction.

### [2-5. Cross Shape]

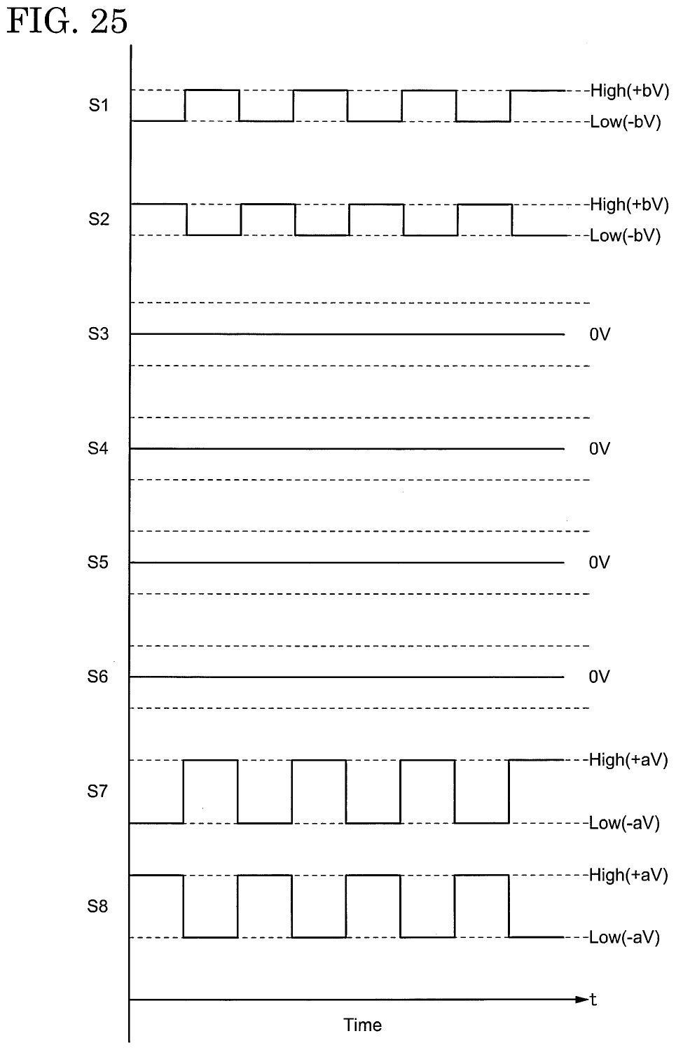

FIG. 25 is a timing chart showing signals input to the optical element 10C for controlling the light distribution having a cross shape in the present embodiment.

As shown in FIG. 25, each of the first signal S1, the second signal S2, the seventh signal S7, and the eighth signal S8 has an AC rectangular wave in which a high voltage and a low voltage are alternately repeated. However, the first signal S1 and the second signal S2 have inverted phases, and the seventh signal S7 and the eighth signal S8 have inverted phases. Further, each of the third signal S3 to the sixth signal S6 is 0V. In this case, the first signal S1 and the second signal S2 generate a lateral electric field in the y-axis direction between the third transparent electrode 120-3 and the fourth transparent electrode 120-4 of each of the second liquid crystal cell 100C-2 and the third liquid crystal cell 100C-3. Therefore, the P-polarization component of the light emitted from the light source 20 is diffused only in the y-axis direction in the second liquid crystal cell 100C-2 and the third liquid crystal cell 100C-3. Further, the seventh signal S7 and the eighth signal S8 generate a lateral electric field in the x-axis direction between the third transparent electrode 120-3 and the fourth transparent electrode 120-4 of each of the first liquid crystal cell 100C-1 and the fourth liquid crystal cell 100C-4. Therefore, the S-polarization component of the light emitted from the light source 20 is diffused only in the x-axis direction in the first liquid crystal cell 1000-1 and the fourth liquid crystal cell 1000-4. Accordingly, since each of the P-polarization component and the S-polarization component is diffused only in one direction of the x-axis direction and the y-axis direction, the light passing through the optical element 10 has a cross shape selectively spreading in the x-axis direction and the y-axis direction. The diffusion width in the x-axis direction (light distribution angle in the x-axis direction) and the diffusion width in the y-axis direction (light distribution angle in the y-axis direction) can be controlled by adjusting the amplitude a and the amplitude b, respectively.

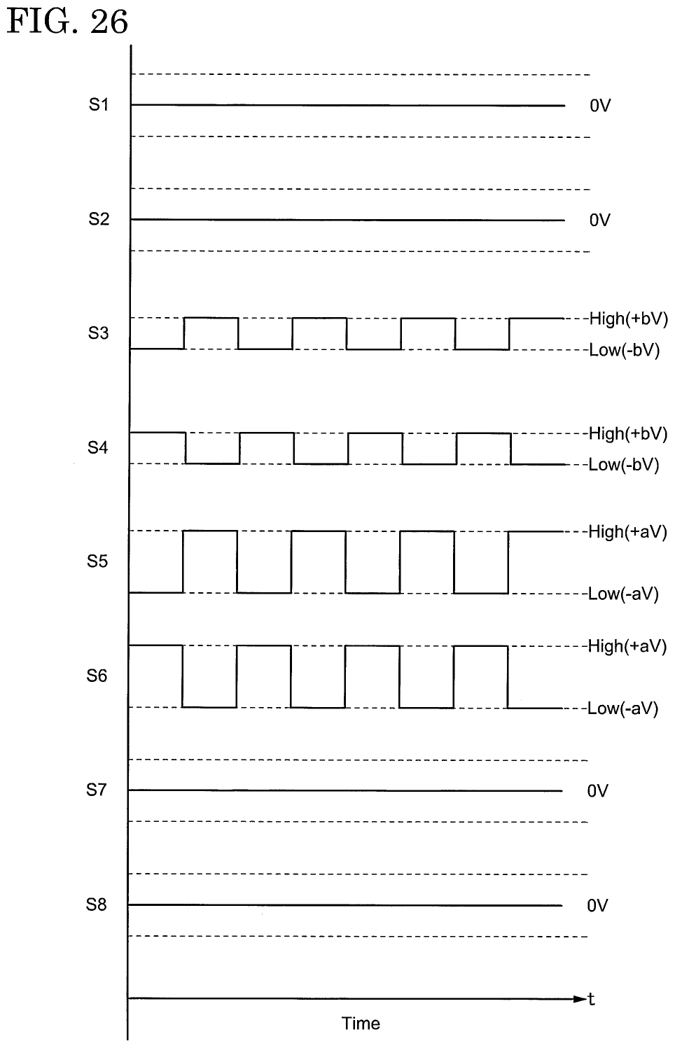

In addition, a timing chart for controlling the light distribution having a cross shape is not limited to the timing chart shown in FIG. 25. In the following description, a modification of the timing chart for controlling the light distribution having a cross shape is described with reference to FIG. 26.

FIG. 26 is another timing chart showing signals input to the optical element 10C for controlling the light distribution having a cross shape in the present embodiment.

As shown in FIG. 26, each of the third signal S3 to the sixth signal S6 has an AC rectangular wave in which a high voltage and a low voltage are alternately repeated. However, the third signal S3 and the fourth signal S4 have inverted phases, and the fifth signal S5 and the sixth signal S6 have inverted phases. Further, each of the first signal S1, the second signal S2, the seventh signal S7, and the eighth signal S8 is 0V. In this case, the third signal S3 and the fourth signal S4 generate a lateral electric field in the x-axis direction between the first transparent electrode 120-1 and the second transparent electrode 120-2 of each of the second liquid crystal cell 1000-2 and the third liquid crystal cell 1000-3. Therefore, the P-polarization component of the light emitted from the light source 20 is diffused only in the x-axis direction in the second liquid crystal cell 1000-2 and the third liquid crystal cell 1000-3. Further, the fifth signal S5 and the sixth signal S6 generate a lateral electric field in the y-axis direction between the first transparent electrode 120-1 and the second transparent electrode 120-2 of each of the first liquid crystal cell 1000-1 and the fourth liquid crystal cell 1000-4. Therefore, the S-polarization component of the light emitted from the light source 20 is diffused only in the y-axis direction in the first liquid crystal cell 1000-1 and the fourth liquid crystal cell 1000-4. Accordingly, since each of the P-polarization component and the S-polarization component is diffused only in one direction of the x-axis direction and the y-axis direction, the light passing through the optical element 10C has a cross shape selectively spreading in the x-axis direction and the y-axis direction. The diffusion width in the x-axis direction (light distribution angle in the x-axis direction) and the diffusion width in the y-axis direction (light distribution angle in the y-axis direction) can be controlled by adjusting the amplitude b and the amplitude a, respectively.

As described above, in the present embodiment, the arrangement direction of the liquid crystal cell 100 described in the First Embodiment can be changed to manufacture the optical element 10C different from the optical element 10. In the optical element 10C, a voltage can be simultaneously applied to the multiple transparent electrodes 120 included in the multiple liquid crystal cells 1000 via the inter-cell conductive electrodes 4000 provided on the side surfaces of the optical element 10C to control the light distribution. Therefore, since the number of signals input to the optical element 10C can be reduced, the control of the light distribution of the optical element 10C is simplified. Further, since the number of terminals 210 electrically connected to the transparent electrodes 120 is reduced, the wiring connection in the mounting process is simplified, and the manufacturing yield of the optical element 10C is improved. Furthermore, the lighting device 1C including the optical element 10C also has excellent light distribution control and improves the manufacturing yield.

Within the scope of the present invention, those skilled in the art may conceive of examples of changes and modifications, and it is understood that these examples of changes and modifications are also included within the scope of the present invention. For example, additions, deletions, or design changes of constituent elements, or additions, omissions, or changes to conditions of steps as appropriate based on the respective embodiments described above are also included within the scope of the present invention as long as the gist of the present invention is provided.

Further, other effects which differ from those brought about by the embodiment, but which are apparent from the description herein or which can be readily predicted by those skilled in the art, are naturally understood to be brought about by the present invention.

What is claimed is:

1. An optical element, comprising:
a first liquid crystal cell, a second liquid crystal cell, a third liquid crystal cell, and a fourth liquid crystal cell stacked in sequence,
wherein:
each of the first liquid crystal cell, the second liquid crystal cell, the third liquid crystal cell, and the fourth liquid crystal cell comprises:
a first substrate on which a first electrode, a second electrode, a first connection pad electrically connected to the first electrode, and a second connection pad electrically connected to the second electrode are provided,
a second substrate on which a third electrode, a fourth electrode, a third connection pad electrically connected to the third electrode, and a fourth connection pad electrically connected to the fourth electrode are provided, and
a liquid crystal layer provided between the first substrate and the second substrate,
the second substrate of the second liquid crystal cell faces the second substrate of the first liquid crystal cell,
the first substrate of the third liquid crystal cell faces the first substrate of the second liquid crystal cell,
the second substrate of the fourth liquid crystal cell faces the second substrate of the third liquid crystal cell,
the first connection pad of the first liquid crystal cell is electrically connected to the first connection pad of the third liquid crystal cell via a first inter-cell conductive electrode,
the second connection pad of the first liquid crystal cell is electrically connected to the second connection pad of the third liquid crystal cell via a second inter-cell conductive electrode,
the third connection pad of the first liquid crystal cell is electrically connected to the third connection pad of the third liquid crystal cell via a third inter-cell conductive electrode,
the fourth connection pad of the first liquid crystal cell is electrically connected to the fourth connection pad of the third liquid crystal cell via a fourth inter-cell conductive electrode,
the first connection pad of the second liquid crystal cell is electrically connected to the first connection pad of the fourth liquid crystal cell via a fifth inter-cell conductive electrode,
the second connection pad of the second liquid crystal cell is electrically connected to the second connection pad of the fourth liquid crystal cell via a sixth inter-cell conductive electrode,
the third connection pad of the second liquid crystal cell is electrically connected to the third connection pad of the fourth liquid crystal cell via a seventh inter-cell conductive electrode, and
the fourth connection pad of the second liquid crystal cell is electrically connected to the fourth connection pad of the fourth liquid crystal cell via an eighth inter-cell conductive electrode.

2. The optical element according to claim 1,
wherein:
in a plan view, at least a portion of the first connection pad and at least a portion of the second connection pad are exposed from the second substrate, and
in the plan view, at least a portion of the third connection pad and at least a portion of the fourth connection pad are exposed from the first substrate.

3. The optical element according to claim 1, wherein in a plan view, each of the first liquid crystal cell, the second liquid crystal cell, the third liquid crystal cell, and the fourth liquid crystal cell is substantially square or substantially rectangular.

4. The optical element according to claim 1, further comprises:
a first terminal connection substrate disposed adjacent to the first liquid crystal cell and provided with a first terminal, a second terminal, a third terminal, and a fourth terminal; and
a second terminal connection substrate disposed adjacent to the fourth liquid crystal cell and provided with a fifth terminal, a sixth terminal, a seventh terminal, and an eighth terminal,
wherein:
the first inter-cell conductive electrode, the second inter-cell conductive electrode, the third inter-cell conductive electrode, and the fourth inter-cell conductive electrode are electrically connected to the first terminal, the second terminal, the third terminal, and the fourth terminal, respectively, and
the fifth inter-cell conductive electrode, the sixth inter-cell conductive electrode, the seventh inter-cell conductive electrode, and the eighth inter-cell conductive electrode are electrically connected to the fifth terminal, the sixth terminal, the seventh terminal, and the eighth terminal, respectively.

5. The optical element according to claim 1, further comprises:
a terminal connection substrate disposed adjacent to one of the first liquid crystal cell and the fourth liquid crystal cell, and provided with a first terminal, a second terminal, a third terminal, a fourth terminal, a fifth terminal, a sixth terminal, a seventh terminal, and an eighth terminal,
wherein the first inter-cell conductive electrode, the second inter-cell conductive electrode, the third inter-cell conductive electrode, the fourth inter-cell conductive electrode, the fifth inter-cell conductive electrode, the sixth inter-cell conductive electrode, the seventh inter-cell conductive electrode, and the eighth inter-cell conductive electrode are electrically connected to the first terminal, the second terminal, the third terminal, the fourth terminal, the fifth terminal, the sixth terminal, the seventh terminal, and the eighth terminal, respectively.

6. A lighting device, comprising:
the optical element according to claim 1; and
a light source disposed adjacent to the first liquid crystal cell.

7. An optical element, comprising:
a first liquid crystal cell, a second liquid crystal cell, a third liquid crystal cell, and a fourth liquid crystal cell stacked in sequence,
wherein:
each of the first liquid crystal cell, the second liquid crystal cell, the third liquid crystal cell, and the fourth liquid crystal cell comprises:
a first substrate on which a first electrode, a second electrode, a first connection pad electrically connected to the first electrode, and a second connection pad electrically connected to the second electrode are provided,
a second substrate on which a third electrode, a fourth electrode, a third connection pad electrically connected to the third electrode, and a fourth connection pad electrically connected to the fourth electrode are provided, and
a liquid crystal layer provided between the first substrate and the second substrate,
wherein:
the second substrate of the second liquid crystal cell faces the second substrate of the first liquid crystal cell,
the first substrate of the third liquid crystal cell faces the first substrate of the second liquid crystal cell,
the second substrate of the fourth liquid crystal cell faces the second substrate of the third liquid crystal cell,
the third connection pad of the second liquid crystal cell is electrically connected to the first connection pad of the third liquid crystal cell via a first inter-cell conductive electrode,
the fourth connection pad of the second liquid crystal cell is electrically connected to the second connection pad of the third liquid crystal cell via a second inter-cell conductive electrode,
the first connection pad of the second liquid crystal cell is electrically connected to the third connection pad of the third liquid crystal cell via a third inter-cell conductive electrode,
the second connection pad of the second liquid crystal cell is electrically connected to the fourth connection pad of the third liquid crystal cell via a fourth inter-cell conductive electrode,
the second connection pad of the first liquid crystal cell is electrically connected to the first connection pad of the fourth liquid crystal cell via a fifth inter-cell conductive electrode,
the first connection pad of the first liquid crystal cell is electrically connected to the second connection pad of the fourth liquid crystal cell via a sixth inter-cell conductive electrode,
the fourth connection pad of the first liquid crystal cell is electrically connected to the third connection pad of the fourth liquid crystal cell via a seventh inter-cell conductive electrode, and
the third connection pad of the first liquid crystal cell is electrically connected to the fourth connection pad of the fourth liquid crystal cell via an eighth inter-cell conductive electrode.

8. The optical element according to claim 7,
wherein:
in a plan view, at least a portion of the first connection pad and at least a portion of the second connection pad are exposed from the second substrate, and
in the plan view, at least a portion of the third connection pad and at least a portion of the fourth connection pad are exposed from the first substrate.

9. The optical element according to claim 7, wherein in a plan view, each of the first liquid crystal cell, the second liquid crystal cell, the third liquid crystal cell, and the fourth liquid crystal cell is substantially square or substantially rectangular.

10. The optical element according to claim 7, further comprises:
a first terminal connection substrate disposed adjacent to the first liquid crystal cell and provided with a first terminal, a second terminal, a third terminal, and a fourth terminal; and
a second terminal connection substrate disposed adjacent to the fourth liquid crystal cell and provided with a fifth terminal, a sixth terminal, a seventh terminal, and an eighth terminal,
wherein:
the first inter-cell conductive electrode, the second inter-cell conductive electrode, the third inter-cell conductive electrode, and the fourth inter-cell conductive electrode are electrically connected to the first terminal, the second terminal, the third terminal, and the fourth terminal, respectively, and
the fifth inter-cell conductive electrode, the sixth inter-cell conductive electrode, the seventh inter-cell conductive electrode, and the eighth inter-cell conductive electrode are electrically connected to the fifth terminal, the sixth terminal, the seventh terminal, and the eighth terminal, respectively.

11. The optical element according to claim 7, further comprises:
a terminal connection substrate disposed adjacent to one of the first liquid crystal cell and the fourth liquid crystal cell, and provided with a first terminal, a second terminal, a third terminal, a fourth terminal, a fifth terminal, a sixth terminal, a seventh terminal, and an eighth terminal,
wherein the first inter-cell conductive electrode, the second inter-cell conductive electrode, the third inter-cell conductive electrode, the fourth inter-cell conductive electrode, the fifth inter-cell conductive electrode, the sixth inter-cell conductive electrode, the seventh inter-cell conductive electrode, and the eighth inter-cell conductive electrode are electrically connected to the first terminal, the second terminal, the third terminal, the fourth terminal, the fifth terminal, the sixth terminal, the seventh terminal, and the eighth terminal, respectively.

12. A lighting device, comprising:
the optical element according to claim 7; and
a light source disposed adjacent to the first liquid crystal cell.
